(19) United States
(12) Patent Application Publication
(10) Pub. No.: US 2026/0317520 A1
(43) Pub. Date: Oct. 15, 2026

(54) POLYETHYLENE COMPOSITIONS, ORIENTED POLYETHYLENE FILMS AND ARTICLES COMPRISING THE SAME

(71) Applicant: Dow Global Technologies LLC, Midland, MI (US)

(72) Inventors: Lanhe Zhang, Manvel, TX (US); Johnathan E. DeLorbe, Manvel, TX (US); Douglas S. Ginger, Houston, TX (US); Dibyaranjan Mekap, Pearland, TX (US); Zhe Du, Shanghai (CN); Jianping Pan, Shanghai (CN)

(21) Appl. No.: 19/104,566

(22) PCT Filed: Sep. 5, 2022
(86) PCT No.: PCT/CN2022/117093

§ 371 Date: Feb. 18, 2025

(51) Int. Cl. C08L 23/0807; B32B 27/08; B32B 27/32; B32B 27/34; C08F 2/00; C08F 2/01

(52) U.S. Cl. CPC C08L 23/0815; B32B 27/08; B32B 27/327; B32B 27/34; C08F 2/001; C08F 2/01; B32B 2250/24; B32B 2270/00; B32B 2307/40; B32B 2307/518; C08L 2203/16; C08L 2205/025; C08L 2205/03; C08L 2314/02

(57) ABSTRACT

Disclosed is polyethylene compositions include three polyethylene components, oriented polyethylene films include such polyethylene compositions, laminates include such polyethylene compositions, and articles include such polyethylene compositions. The polyethylene compositions can have good processability and stretchability into oriented polyethylene films (e.g., high throughput rate during film casting), and the oriented polyethylene films produced from such polyethylene compositions can be compatible with polyethylene recycling streams and can have a desirable balance of stretchability, elongation, modulus, haze, and clarity.

### FIELD

The present invention relates to polyethylene compositions, to oriented polyethylene films comprising such polyethylene compositions, to laminates comprising such polyethylene compositions, and to articles comprising such polyethylene compositions.

### INTRODUCTION

As global interest solidifies in reducing packaging waste and making flexible packaging more sustainable, there is an increasing amount of effort to develop materials and technologies that would enhance the sustainability of flexible packaging. Flexible packaging film structures are often formed of multiple types of polymeric materials including, for example, polyethylene, polypropylene, ethylene vinyl alcohol, polyethylene terephthalate, polyamide and others. Such materials are typically combined to achieve a balance of properties that are beyond the reach of a single material type. However, due to the dissimilarity of these materials, the final package is typically not easy to recycle. Thus, there is also a movement towards single component structures (e.g., all polyethylene structures) to improve the recyclability profile. In the case of all polyethylene structures, for example, certain performance metrics (e.g., mechanical properties) will need to be enhanced to maintain the level of performance expected of these structures when formed from different polymeric materials, while improving recyclability. Thus, new resin and processing technologies will be needed to bridge performance deficiencies of polyethylene relative to other material types.

One such relatively new material technology on the processing side is biaxially oriented polyethylene (BOPE) films. Such BOPE films can be formed by cast extrusion, and are then oriented in the machine direction (MD) followed by orientation in the cross or transverse direction (TD) in a tenter frame. Alternatively, this process can also be performed simultaneously. Due to the molecular architecture, microstructure and crystallization kinetics of polyethylene, it is often difficult to biaxially orient conventional polyethylene. Moreover, it is difficult to balance optics and stiffness properties of BOPE films made from conventional polyethylene, and such BOPE films can have a lower modulus due to a lower density of the polyethylene resins that can be used for biaxial orientation, which can negatively impact the temperature resistance and processability of the film.

Accordingly, there remains a need for polyethylene compositions that have good processability and stretchability into oriented polyethylene films while exhibiting a higher density, associated with a higher melting point and therefore higher thermal resistance (e.g., high throughput rate during film casting and packaging process), and for oriented polyethylene films that can be compatible with polyethylene recycling streams and that have a desirable balance of stretchability, elongation, modulus, haze, and clarity.

### SUMMARY

The present invention provides a polyethylene composition suitable for processing into oriented polyethylene films, as well as oriented polyethylene films having desired properties, such as a desirable balance of stretchability, elongation, modulus, haze, and clarity. The polyethylene composition, in some embodiments, can advantageously expand the operating window for stretching films to provide oriented polyethylene films and can be processed at a high throughput rate during film casting. The polyethylene composition, in some embodiments, can provide a one-pellet solution without the need for a blend or skin layer, and can produce films with desirable balance of optics and stiffness in comparison to existing films.

In one aspect, the present invention relates to a polyethylene composition comprising:
(a) from 15 to 25 percent by weight of a first polyethylene component having a molecular weight (Mw) of greater than 200,000 g/mol and a density of from 0.925 to 0.945 g/cc;
(b) from 20 to 35 percent by weight of a second polyethylene component having a molecular weight (Mw) of less than 80,000 g/mol and a density of from 0.915 to 0.950 g/cc; and
(c) from 40 to 65 percent by weight of a third polyethylene component having a molecular weight (Mw) of less than 100,000 g/mol and density of from 0.940 to 0.965 g/cc; and
wherein the polyethylene composition has a density of from 0.935 to 0.958 g/cc, a melt index (I₂) of from 0.5 to 5 g/10 min, and satisfies the following equation: First Polyethylene Component Weight Fraction*SCB_{log Mw4-5}*Mz (conv. GPC)>230,000.

In another aspect, the present invention relates to uniaxially oriented films. A uniaxially oriented film can comprise the polyethylene composition disclosed herein.

In another aspect, the present invention relates to biaxially oriented films. A biaxially oriented film can comprise the polyethylene composition disclosed herein.

In another aspect, the present invention relates to laminates. In some embodiments, the laminate comprises a first film comprising a polyethylene sealant film, polypropylene, or polyamide; and the biaxially oriented film according to embodiments disclosed herein, wherein the first film is laminated to the biaxially oriented film.

In another aspect, the present invention relates to articles. In some embodiments, an article comprises any of the laminates, films, and/or polyethylene compositions disclosed herein.

These and other embodiments are described in more detail in the Detailed Description.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 is a graphic description of the reactor stream feed data flows for inventive and comparative compositions disclosed herein.

### DETAILED DESCRIPTION

Unless stated to the contrary, implicit from the context, or customary in the art, all parts and percentages are based on weight, all temperatures are in ° C., and all test methods are current as of the filing date of this disclosure.

The term “composition,” as used herein, refers to a mixture of materials which comprises the composition, as well as reaction products and decomposition products formed from the materials of the composition.

The term “polymer” means a polymeric compound prepared by polymerizing monomers, whether of the same or a different type. The generic term polymer thus embraces the term homopolymer as defined hereafter, and the term interpolymer as defined hereinafter. Trace amounts of impurities (for example, catalyst residues) may be incorporated into and/or within the polymer. A polymer may be a single polymer, a polymer blend or a polymer mixture, including mixtures of polymers that are formed in situ during polymerization.

The term “homopolymer,” as used herein, refers to polymers prepared from only one type of monomer with the understanding that trace amounts of impurities can be incorporated into the polymer structure.

The term “interpolymer,” as used herein, refers to polymers prepared by the polymerization of at least two different types of monomers. The generic term interpolymer thus includes copolymers (employed to refer to polymers prepared from two different types of monomers), and polymers prepared from more than two different types of monomers.

The terms “olefin-based polymer” or “polyolefin”, as used herein, refer to a polymer that comprises, in polymerized form, a majority amount of olefin monomer, for example ethylene or propylene (based on the weight of the polymer), and optionally may comprise one or more comonomers.

The term, “ethylene/α-olefin interpolymer,” as used herein, refers to an interpolymer that comprises, in polymerized form, a majority amount (>50 mol %) of units derived from ethylene monomer, and the remaining units derived from one or more α-olefins. Typical α-olefins used in forming ethylene/α-olefin interpolymers are C₃-C₁₀ alkenes.

The term, “ethylene/α-olefin copolymer,” as used herein, refers to a copolymer that comprises, in polymerized form, a majority amount (>50 mol %) of ethylene monomer, and an α-olefin, as the only two monomer types.

The term “α-olefin”, as used herein, refers to an alkene having a double bond at the primary or alpha (a) position.

“Polyethylene” or “ethylene-based polymer” shall mean polymers comprising a majority amount (>50 mol %) of units which have been derived from ethylene monomer. This includes polyethylene homopolymers or copolymers (meaning units derived from two or more comonomers). Common forms of polyethylene known in the art include Low Density Polyethylene (LDPE); Linear Low Density Polyethylene (LLDPE); Ultra Low Density Polyethylene (ULDPE); single-site catalyzed Linear Low Density Polyethylene, including both linear and substantially linear low density resins (m-LLDPE); ethylene-based plastomers (POP) and ethylene-based elastomers (POE); Medium Density Polyethylene (MDPE); and High Density Polyethylene (HDPE). These polyethylene materials are generally known in the art; however, the following descriptions may be helpful in understanding the differences between some of these different polyethylene resins.

The term “LDPE” may also be referred to as “high pressure ethylene polymer” or “highly branched polyethylene” and is defined to mean that the polymer is partly or entirely homo-polymerized or copolymerized in autoclave or tubular reactors at pressures above 14,500 psi (100 MPa) with the use of free-radical initiators, such as peroxides (see for example U.S. Pat. No. 4,599,392, which is hereby incorporated by reference). LDPE resins typically have a density in the range of 0.916 to 0.935 g/cm³.

The term “LLDPE”, includes both resin made using the traditional Ziegler-Natta catalyst systems and chromium-based catalyst systems as well as single-site catalysts, including, but not limited to, substituted mono- or bis-cyclopentadienyl catalysts (typically referred to as metallocene), constrained geometry catalysts, pyridylamine catalysts, phosphinimine catalysts & polyvalent aryloxyether catalysts (typically referred to as bisphenyl phenoxy), and includes linear, substantially linear or heterogeneous polyethylene copolymers or homopolymers. LLDPEs contain less long chain branching than LDPEs and includes the substantially linear ethylene polymers which are further defined in U.S. Pat. Nos. 5,272,236, 5,278,272, 5,582,923 and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. No. 3,914,342 or U.S. Pat. No. 5,854,045). The LLDPEs can be made via gas-phase, solution-phase or slurry polymerization or any combination thereof, using any type of reactor or reactor configuration known in the art.

The term “MDPE” refers to polyethylenes having densities from 0.926 to 0.935 g/cm³. “MDPE” is typically made using chromium or Ziegler-Natta catalysts or using single-site catalysts including, but not limited to, substituted mono- or bis-cyclopentadienyl catalysts (typically referred to as metallocene), constrained geometry catalysts, pyridylamine catalysts, phosphinimine catalysts & polyvalent aryloxyether catalysts (typically referred to as bisphenyl phenoxy), and typically have a molecular weight distribution (“MWD”) greater than 2.5.

The term “HDPE” refers to polyethylenes having densities greater than about 0.935 g/cm³ and up to about 0.980 g/cm³, which are generally prepared with Ziegler-Natta catalysts, chrome catalysts or single-site catalysts including, but not limited to, substituted mono- or bis-cyclopentadienyl catalysts (typically referred to as metallocene), constrained geometry catalysts, pyridylamine catalysts, phosphinimine catalysts & polyvalent aryloxyether catalysts (typically referred to as bisphenyl phenoxy).

The term “ULDPE” refers to polyethylenes having densities of 0.855 to 0.912 g/cm³, which are generally prepared with Ziegler-Natta catalysts, chrome catalysts, or single-site catalysts including, but not limited to, substituted mono- or bis-cyclopentadienyl catalysts (typically referred to as metallocene), constrained geometry catalysts, pyridylamine catalysts, phosphinimine catalysts & polyvalent aryloxyether catalysts (typically referred to as bisphenyl phenoxy). ULDPEs include, but are not limited to, polyethylene (ethylene-based) plastomers and polyethylene (ethylene-based) elastomers. Polyethylene (ethylene-based) elastomers plastomers generally have densities of 0.855 to 0.912 g/cm³.

The terms “blend” and “polymer blend” mean a composition of two or more polymers. Such a blend may or may not be miscible. Such a blend may or may not be phase separated. Such a blend may or may not contain one or more domain configurations, as determined from transmission electron spectroscopy, light scattering, x-ray scattering, and any other method known in the art. Blends are not laminates, but one or more layers of a laminate may contain a blend. Such blends can be prepared as dry blends, formed in situ (e.g., in a reactor), melt blends, or using other techniques known to those of skill in the art.

The term “multimodal” means compositions that can be characterized by having at least three (3) polymer subcomponents with varying densities and weight average molecular weights, and optionally, may also have different melt index values. In one embodiment, multimodal may be defined by having at least three distinct peaks in a Gel Permeation Chromatography (GPC) chromatogram showing the molecular weight distribution. In another embodiment, multimodal may be defined by having at least three distinct peaks in a Crystallization Elution Fractionation (CEF) chromatogram showing the short chain branching distribution. In another embodiment, multimodal may be defined by having at least three distinct peaks in an improved comonomer composition distribution (iCCD) elution profile. Multimodal includes compositions having three peaks as well as compositions having more or less than three peaks in GPC, CEF or iCCD, as long as the compositions can be characterized, in accordance with the test methods below, as having at least (3) polymer subcomponents with varying densities and weight average molecular weights.

The term “trimodal polymer” means a multimodal ethylene-based polymer having three primary components: a first polyethylene component, a second polyethylene component, and a third polyethylene component.

“Polyethylene component,” for example, the “first polyethylene component,” the “second polyethylene component,” or the “third polyethylene component,” refers to subcomponents of the polyethylene composition disclosed herein (i.e., the multimodal or trimodal polymer), wherein each subcomponent is a polyethylene comprising ethylene monomer and, optionally, C₃-C₁₂ α-olefin comonomer.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

The present invention generally relates to polyethylene compositions that can be suitable for oriented films. When incorporated into oriented films, the polyethylene composition can provide desirable performance characteristics, such as desirable clarity, decreased haze, and improved modulus. Without wishing to be bound by theory, it is believed that the unique design of the polyethylene composition—including, for example, a three component composition and desirable balance of a first polyethylene component weight fraction, Z average molecular weight (Mz), and an average short chain branch level in a portion between log(Mw) of 4.0 to 5.0 (SCB_{log Mw4-5})—delivers improved processability, stretchability, and performance characteristics. The inventive polyethylene compositions can be incorporated into uniaxially oriented films, biaxially oriented films, laminates, and articles having enhanced performance characteristics, such as desirable clarity, decreased haze, and improved modulus.

Because the inventive compositions are polyethylene-based, in some embodiments, the films, laminates, and articles can be formed entirely or substantially entirely from polyethylene making the films, laminates, and articles more readily recyclable.

In one aspect, a polyethylene composition comprises:
(a) from 15 to 25 percent by weight of a first polyethylene component having a molecular weight (Mw) of greater than 200,000 g/mol and a density of from 0.925 to 0.945 g/cc;
(b) from 20 to 35 percent by weight of a second polyethylene component having a molecular weight (Mw) of less than 80,000 g/mol and a density of from 0.915 to 0.950 g/cc; and
(c) from 40 to 65 percent by weight of a third polyethylene component having a molecular weight (Mw) of less than 100,000 g/mol and density of from 0.940 to 0.965 g/cc; and
wherein the polyethylene composition has a density of from 0.935 to 0.958 g/cc, a melt index (I₂) of from 0.5 to 5 g/10 min, and satisfies the following equation:

First Polyethylene Component Weight Fraction*SCB_{log Mw4-5}*Mz (conv. GPC)>230,000.

In the foregoing equation, “First Polyethylene Component Weight Fraction” is the percent by weight of the first polyethylene component converted to a fraction. For example, a composition having 25 percent by weight of a first polyethylene component has a 0.25 value for the “First Polyethylene Component Weight Fraction.” The “SCB_{log Mw4-5}” is the average short chain branch level in a portion between log(Mw) of 4.0 to 5.0 of the polyethylene composition, as measured in accordance with the test method below. The “Mz (conv. GPC)” is the Z average molecular weight of the polyethylene composition, as measured in accordance with the conventional GPC tested method below. For example, a polyethylene composition disclosed herein may have 21 percent by weight of a first polyethylene component, a SCB_{log Mw4-5} of 4.28, and an Mz (conv. GPC) of 367,362 g/mol, which equates to 330,185 (i.e., 0.21*4.28*367,362=330,185) and is greater than 230,000. In some embodiments, First Polyethylene Component Weight Fraction*SCB_{log Mw4-5}*Mz (conv. GPC)>250,000, or alternatively>275,000, or alternatively >300,000, or alternatively >325,000.

In some embodiments, the polyethylene composition has an average short chain branch level in a portion between log(Mw) of 4.0 to 5.0 (SCB_{log Mw4-5}) that is greater than 3.50 SCB/1000C and less than 10.00 SCB/1000C.

In some embodiments, the first polyethylene component has a peak temperature in an elution profile via improved comonomer composition distribution (iCCD) of greater than 99.5° C. In some embodiments, the polyethylene composition has a Mz/Mw from 3.5 to 4.5. In some embodiments, the polyethylene composition has a molecular weight distribution (Mw/Mn) of from 4.2 to 10.0. In some embodiments, the polyethylene composition has an I₁₀/I₂ of from 7.0 to 15.0. In some embodiments, the polyethylene composition has a Mz (conv. GPC) of from 250,000 to 450,000 g/mol.

The polyethylene composition may comprise a combination of two or more embodiments as described herein.

### Polyethylene Composition

The polyethylene composition according to embodiments disclosed herein comprises the polymerized reaction product of ethylene monomer and at least one C₃-C₁₂ α-olefin comonomer. The one or more α-olefin comonomers of the polyethylene composition may be selected from the group consisting of propylene, 1-butene, 1-hexene, and 1-octene, or in the alternative, from the group consisting of 1-butene, 1-hexene and 1-octene, or in the alternative, from the group consisting of 1-hexene and 1-octene.

The polyethylene composition has a density of from 0.935 to 0.958 g/cc, a melt index (I₂) of from 0.5 to 5.0 g/10 min, and satisfies the following equation: First Polyethylene Component Weight Fraction*SCB_{log Mw4-5}*Mz (conv. GPC)>230,000. The polyethylene composition can have a density of from 0.935 to 0.958 g/cc, or from 0.936 to 0.954 g/cc, or from 0.935 to 0.950 g/cc, or from 0.935 to 0.945 g/cc, or from 0.936 to 0.945 g/cc. The polyethylene composition can have a melt index (I₂) of from 0.5 to 5.0 g/10 min, or from 0.5 to 3.0 g/10 min, or from 0.5 to 2.0 g/10 min, or from 1.0 to 2.0 g/min. In one or more embodiments, the polyethylene composition has an average short chain branch (SCB) level in a portion between log(Mw) of 4.0 to 5.0 (SCB_{log Mw4-5}) that is greater than 3.50 SCB/1000C, such as greater than 4.00 SCB/1000C, greater than 4.50 SCB/1000C, greater than 5.00 SCB/1000C, greater than 5.50 SCB/1000C, or greater than 6.00 SCB/1000C. In one or more embodiments, the maximum average SCB level in the portion between log(Mw) of 4.0 to 5.0 (SCB_{log Mw4-5}) is 8.00 SCB/1000C, or 7.0 SCB/1000C. SCB_{log Mw4-5} is measured according to the test method described herein below.

The polyethylene composition can have a molecular weight distribution (Mw/Mn) of from 4.2 to 10.0, or from 4.2 to 8.0. or from 4.2 to 6.0, or from 4.3 to 6.0. The polyethylene composition can have an I₁₀/I₂ of from 7.0 to 15.0, or from 8.0 to 15, or from 7.0 to 14.0, or from 7.0 to 13.0.

The polyethylene composition disclosed herein has three components: a first polyethylene component, a second polyethylene component, and a third polyethylene component.

The polyethylene composition comprises from 15 to 25 percent by weight, based on total weight of the polyethylene composition, of a first polyethylene component having a molecular weight (Mw) (also known as a weight average molecular weight) of greater than 200,000 g/mol and a density of from 0.925 to 0.945 g/cc. All individual values and subranges of from 15 to 25 percent by weight are disclosed and included herein. For example, the polyethylene composition can comprise from 15, 16, 17, 18, 19, 20, 21, 22, 23, or 24 to 25, 24, 23, 22, 21, 20, 19, 18, 17, or 16 percent by weight, based on total weight of the polyethylene composition, of a first polyethylene component. The first polyethylene component can have a molecular weight (Mw) of greater than 200,000 g/mol, or greater than 210,000 g/mol, or greater than 250,000 g/mol, or greater than 280,000 g/mol, or greater than 300,000 g/mol, or greater than 310,000 g/mol, or from 210,000 g/mol to 400,000 g/mol, where molecular weight (Mw) can be measured in accordance with the test method below. The first polyethylene component can have a density from 0.925 to 0.945 g/cc, or from 0.930 to 0.945 g/cc, or from 0.930 to 0.940 g/cc. The densities for the polyethylene composition components (for example, first, second, and third polyethylene components) are calculated from the equations provided in the below test methods section.

In some embodiments, the first polyethylene component has a peak temperature in an elution profile via improved comonomer composition distribution (iCCD) of greater than 99.5° C. In some embodiments, the first polyethylene component is a homopolymer. In some embodiments, the first polyethylene component can comprise C₃-C₁₂ α-olefin comonomer.

Exemplary α-olefin comonomers include, but are not limited to, propylene, 1-butene, 1-pentene, 1-hexene, 1-heptene, 1-octene, 1-nonene, 1-decene, and 4-methyl-1-pentene. The one or more α-olefin comonomers of the first polyethylene component may be selected from the group consisting of propylene, 1-butene, 1-hexene, and 1-octene, or in the alternative, from the group consisting of 1-butene, 1-hexene and 1-octene, or in the alternative, from the group consisting of 1-hexene and 1-octene.

The polyethylene composition comprises from 20 to 35 percent by weight of a second polyethylene component having a molecular weight (Mw) of less than 80,000 g/mol and a density of from 0.915 to 0.950 g/cc. All individual values and subranges of from 20 to 35 percent by weight are disclosed and included herein. For example, the polyethylene composition can comprise from 20, 21, 22, 23, 24, 25, 26, 27, 28, 29, 30, 31, 32, 33, or 34 to 35, 34, 33, 32, 31, 30, 29, 28, 27, 26, 25, 24, 23, 22, or 21 percent by weight, based on the total weight of the polyethylene composition, of a second polyethylene component. The second polyethylene component can have a molecular weight (Mw) of less than 80,000 g/mol, or less than 70,000 g/mol, or less than 60,000 g/mol, or less than 55,000 g/mol, or from 15,000 g/mol to 75,000 g/mol, where molecular weight (Mw) can be measured in accordance with the test method below. The second polyethylene component can have a density from 0.915 to 0.950 g/cc, or from 0.915 to 0.940 g/cc, or from 0.915 to 0.935 g/cc, or from 0.915 to 0.930 g/cc, or from 0.915 to 0.925 g/cc.

The second polyethylene component can have various levels of C₃-C₁₂ α-olefin comonomer incorporation. In one embodiment, the second polyethylene component can have a higher C₃-C₁₂ α-olefin comonomer incorporation than the first polyethylene component. For example, the second polyethylene component can have 2 to 20 percent by weight of C₃-C₁₂ α-olefin comonomer, or from 3 to 19 percent by weight of C₃-C₁₂ α-olefin comonomer, or from 5 to 17 percent by weight of C₃-C₁₂ α-olefin comonomer. The one or more α-olefin comonomers of the second polyethylene component may be selected from the group consisting of propylene, 1-butene, 1-hexene, and 1-octene, or in the alternative, from the group consisting of 1-butene, 1-hexene and 1-octene, or in the alternative, from the group consisting of 1-hexene and 1-octene.

The polyethylene composition comprises from 40 to 65 percent by weight of a third polyethylene component having a molecular weight (Mw) of less than 100,000 g/mol and a density of from 0.940 to 0.965 g/cc. All individual values and subranges of from 40 to 65 percent by weight are disclosed and included herein. For example, the polyethylene composition can comprise from 40, 41, 43, 45, 47, 49, 51, 53, 55, 57, 59, 61, or 63 to 65, 63, 61, 59, 57, 55, 53, 51, 49, 47, 45, 43, or 41 percent by weight, based on total weight of the polyethylene composition, of a third polyethylene component. The third polyethylene component can have a molecular weight (Mw) of less than 100,000 g/mol, or less than 90,000 g/mol, or less than 80,000 g/mol, or from 15,000 to 90,000 g/mol, where molecular weight (Mw) can be measured in accordance with the test method below. The third polyethylene component can have a density of from 0.940 to 0.965 g/cc, or from 0.942 to 0.965 g/cc, or from 0.942 to 0.963 g/cc.

The third polyethylene component can have various levels of C₃-C₁₂ α-olefin comonomer incorporation. In one embodiment, the third polyethylene component can have a lower C₃-C₁₂ α-olefin comonomer incorporation than the first polyethylene component. For example, the third polyethylene component can have less than 10 percent by weight of C₃-C₁₂ α-olefin comonomer, or from 0.5 to less than 10 percent by weight of C₃-C₁₂ α-olefin comonomer, or from 2 to less than 10 percent by weight of C₃-C₁₂ α-olefin comonomer. The one or more α-olefin comonomers of the third polyethylene component may be selected from the group consisting of propylene, 1-butene, 1-hexene, and 1-octene, or in the alternative, from the group consisting of 1-butene, 1-hexene and 1-octene, or in the alternative, from the group consisting of 1-hexene and 1-octene.

### Polymerization and Catalyst

Various polymerization process embodiments are considered suitable for producing the polyethylene composition. In one or more embodiments, the polyethylene composition is produced through a solution polymerization process in a dual reactor system. These dual solution polymerization reactors may be conventional reactors, e.g., loop reactors, isothermal reactors, adiabatic reactors, and continuous stirred tank reactors in parallel, series, and any combinations thereof. In one embodiment, the polyethylene composition may be produced in two loop reactors in series configuration, the first solution polymerization reactor temperature is in the range from 115 to 200° C., for example, from 135 to 165° C., and the second solution polymerization reactor temperature is in the range from 150 to 215° C., for example, from 185 to 212° C. In the solution polymerization process, ethylene monomer, one or more C₃-C₁₂ α-olefin comonomers, solvent, one or more catalyst systems, and optionally hydrogen, may be fed continuously to the dual solution polymerization reactors (i.e., the first and second solution polymerization reactors).

Various catalysts are considered suitable. These may include, but are not limited to, a Ziegler-Natta catalyst, a chromium catalyst, a metallocene catalyst, a post-metallocene catalyst, a constrained geometry complex (CGC) catalyst, a phosphinimine catalyst, a pyridylamine catalyst, or a bis(biphenylphenoxy) catalyst. Details and examples of CGC catalysts are provided in U.S. Pat. Nos. 5,272,236; 5,278,272; 6,812,289; and WO Publication 93/08221, which are all incorporated herein by reference in their entirety. Details and examples of bis(biphenylphenoxy) catalysts are provided in U.S. Pat. Nos. 6,869,904; 7,030,256; 8,101,696; 8,058,373; 9,029,487, which are all incorporated herein by reference in their entirety. Details and examples of pyridylamine catalysts are provided in WO Publication 18/170138, which is incorporated herein by reference in its entirety. The catalysts utilized in the solution polymerization reactors may vary in order to impart different properties to the first polyethylene component, the second polyethylene component, and the third polyethylene component. For example, it is contemplated to use different catalysts in the solution polymerization reactors to vary the density, melt index, comonomer incorporation, etc. of the first, second, and third polyethylene components. Without being bound by theory, varying these parameters for the first, second, and third polyethylene components may enable the multimodal polyethylene composition to have a desired combination of toughness and processability.

In one or more embodiments, the first solution polymerization reactor, the second solution polymerization reactor, or both may include two catalysts. In a specific embodiment, the first solution polymerization reactor may include two catalysts and the second solution polymerization reactor, which is downstream of the first solution polymerization reactor, includes one catalyst. The two catalysts of the first solution polymerization reactor are homogeneous catalysts, whereas the catalyst of the second solution polymerization reactor could include a homogeneous catalyst, a heterogeneous catalyst, or both. Homogeneous, often referred to as single-site, catalysts are organometallic compounds which typically have a discrete molecular structure, and are used to generate polymers, which have narrow molecular weight distribution, as well as narrow composition distribution, in the case where interpolymers are made. Homogeneous catalysts may be dissolved in a solution process or supported for use in particle forming processes, such as slurry or gas phase. Heterogeneous catalysts are not discrete compounds but rather result from a reaction mixture of metal compounds with precursors to form a complex, which has multiple active sites on some form of a particle. Polymers produced via heterogeneous catalysts typically demonstrate broader molecular weight distributions and, in the case of interpolymers, broader composition distributions than homogeneous catalysts. In exemplary embodiments, the catalysts in the first reactor may be different homogeneous catalysts having differing reactivity ratios in the first reactor environment.

The bis(biphenylphenoxy) catalyst is an example of a homogeneous catalyst. Other examples of homogeneous catalysts include constrained geometry catalysts or pyridylamine catalysts. Examples of heterogeneous catalysts may include heterogeneous Ziegler-Natta catalysts, which are particularly useful at the high polymerization temperatures of the solution process. Examples of such Ziegler-Natta catalysts are those derived from organomagnesium compounds, alkyl halides or aluminum halides or hydrogen chloride, and a transition metal compound. Examples of such catalysts are described in U.S. Pat. Nos. 4,314,912 (Lowery, Jr. et al.), 4,547,475 (Glass et al.), and 4,612,300 (Coleman, III), the teachings of which are incorporated herein by reference.

Particularly suitable organomagnesium compounds include, for example, hydrocarbon soluble dihydrocarbylmagnesium such as the magnesium dialkyls and the magnesium diaryls. Exemplary suitable magnesium dialkyls include particularly n-butyl-secbutylmagnesium, diisopropylmagnesium, di-n-hexylmagnesium, isopropyl-n-butyl-magnesium, ethyl-n-hexylmagnesium, ethyl-n-butylmagnesium, di-n-octylmagnesium and others wherein the alkyl has from 1 to 20 carbon atoms. Exemplary suitable magnesium diaryls include diphenylmagnesium, dibenzylmagnesium and ditolylmagnesium. Suitable organomagnesium compounds include alkyl and aryl magnesium alkoxides and aryloxides and aryl and alkyl magnesium halides with the halogen-free organomagnesium compounds being more desirable.

Bis(biphenylphenoxy) catalysts are multi-component catalyst systems comprising a bis(biphenylphenoxy) procatalyst, cocatalyst, as well as further optional ingredients. The bis(biphenylphenoxy) procatalyst may include a metal-ligand complex according to Formula (I):

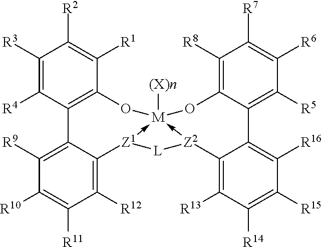

In Formula (I), M is a metal chosen from titanium, zirconium, or hafnium, the metal being in a formal oxidation state of +2, +3, or +4; n is 0, 1, or 2; when n is 1, X is a monodentate ligand or a bidentate ligand; when n is 2, each X is a monodentate ligand and is the same or different; the metal-ligand complex is overall charge-neutral; 0 is 0 (an oxygen atom); each Z is independently chosen from —O—, —S—, —N(R^{N})—, or —P(R^{P})—; L is (C₁-C₄₀)hydrocarbylene or (C₁-C₄₀)heterohydrocarbylene, wherein the (C₁-C₄₀)hydrocarbylene has a portion that comprises a 1-carbon atom to 10-carbon atom linker backbone linking the two Z groups in Formula (I) (to which L is bonded) or the (C₁-C₄₀)heterohydrocarbylene has a portion that comprises a 1-atom to 10-atom linker backbone linking the two Z groups in Formula (I), wherein each of the 1 to 10 atoms of the 1-atom to 10-atom linker backbone of the (C₁-C₄₀)heterohydrocarbylene independently is a carbon atom or heteroatom, wherein each heteroatom independently is O, S, S(O), S(O)₂, Si(R^{C})₂, Ge(R^{C})₂, P(R^{C}), or N(R^{C}), wherein independently each R^{C} is (C₁-C₃₀)hydrocarbyl or (C₁-C₃₀)heterohydrocarbyl; R¹ and R⁸ are independently selected from the group consisting of (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —OR^{C}, —SR^{C}, —NO₂, —CN, —CF₃, R^{C}S(O)—, R^{C}S(O)₂—, (R^{C})₂C═N—, R^{C}C(O)O—, R^{C}OC(O)—, R^{C}C(O)N(R^{N})—, (R^{N})₂NC(O)—, halogen, and radicals having Formula (II), Formula (III), or Formula (IV):

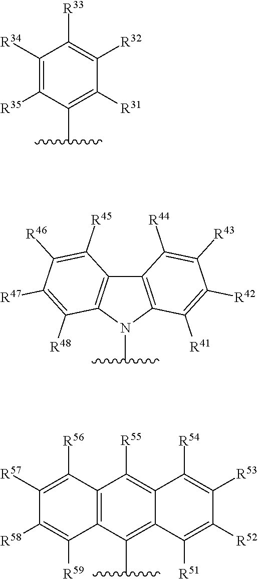

In Formulas (II), (III), and (IV), each of R³¹⁻³⁵, R⁴¹⁻⁴⁸, or R⁵¹⁻⁵⁹ is independently chosen from (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —OR^{C}, —SR^{C}, —NO₂, —CN, —CF₃, R^{C}S(O)—, R^{C}S(O)₂—, (R^{C})₂C═N—, R^{C}C(O)O—, R^{C}OC(O)—, R^{C}C(O)N(R^{N})—, (R^{N})₂NC(O)—, halogen, or —H, provided at least one of R¹ or R⁸ is a radical having Formula (II), Formula (III), or Formula (IV).

In Formula (I), each of R²⁻⁴, R⁵⁻⁷, and R⁹⁻¹⁶ is independently selected from (C₁-C₄₀)hydrocarbyl, (C₁-C₄₀)heterohydrocarbyl, —Si(R^{C})₃, —Ge(R^{C})₃, —P(R^{P})₂, —N(R^{N})₂—OR^{C}, —SR^{C}, —NO₂, —CN, —CF₃, R^{C}S(O)—, R^{C}S(O)₂—, (R^{C})₂C═N—, R^{C}C(O)O—, R^{C}OC(O)—, R^{C}C(O)N(R^{N})—, (R^{c})₂NC(O)—, halogen, and —H.

Specific embodiments of catalyst systems will now be described. It should be understood that the catalyst systems of this disclosure may be embodied in different forms and should not be construed as limited to the specific embodiments set forth in this disclosure. Rather, embodiments are provided so that this disclosure will be thorough and complete, and will fully convey the scope of the subject matter to those skilled in the art.

The term “independently selected” is used herein to indicate that the R groups, such as, R¹, R², R³, R⁴, and R⁵ can be identical or different (e.g., R¹, R², R³, R⁴, and R⁵ may all be substituted alkyls or R¹ and R² may be a substituted alkyl and R³ may be an aryl, etc.). Use of the singular includes use of the plural and vice versa (e.g., a hexane solvent, includes hexanes). A named R group will generally have the structure that is recognized in the art as corresponding to R groups having that name. These definitions are intended to supplement and illustrate, not preclude, the definitions known to those of skill in the art.

The term “procatalyst” refers to a compound that has catalytic activity when combined with an activator. The term “activator” refers to a compound that chemically reacts with a procatalyst in a manner that converts the procatalyst to a catalytically active catalyst. As used herein, the terms “cocatalyst” and “activator” are interchangeable terms.

When used to describe certain carbon atom-containing chemical groups, a parenthetical expression having the form “(Cₓ-C_{y})” means that the unsubstituted form of the chemical group has from x carbon atoms to y carbon atoms, inclusive of x and y. For example, a (C₁-C₄₀)alkyl is an alkyl group having from 1 to 40 carbon atoms in its unsubstituted form. In some embodiments and general structures, certain chemical groups may be substituted by one or more substituents such as R^{S}. An R^{S} substituted version of a chemical group defined using the “(Cₓ-C_{y})” parenthetical may contain more than y carbon atoms depending on the identity of any groups R^{S}. For example, a “(C₁-C₄₀)alkyl substituted with exactly one group R^{S}, where R^{S} is phenyl (—C₆H₅)” may contain from 7 to 46 carbon atoms. Thus, in general when a chemical group defined using the “(Cₓ-C_{y})” parenthetical is substituted by one or more carbon atom-containing substituents R^{S}, the minimum and maximum total number of carbon atoms of the chemical group is determined by adding to both x and y the combined sum of the number of carbon atoms from all of the carbon atom-containing substituents R^{S}.

In some embodiments, each of the chemical groups (e.g., X, R, etc.) of the metal-ligand complex of Formula (I) may be unsubstituted having no R^{S} substituents. In other embodiments, at least one of the chemical groups of the metal-ligand complex of Formula (I) may independently contain one or more than one R^{S}. In some embodiments, the sum total of R^{S} in the chemical groups of the metal-ligand complex of Formula (I) does not exceed 20. In other embodiments, the sum total of R^{S} in the chemical groups does not exceed 10. For example, if each R¹⁻⁵ was substituted with two R^{S}, then X and Z cannot be substituted with an R^{S}. In another embodiment, the sum total of R^{S} in the chemical groups of the metal-ligand complex of Formula (I) may not exceed 5 R^{S}. When two or more than two R^{S} are bonded to a same chemical group of the metal-ligand complex of Formula (I), each R^{S} is independently bonded to the same or different carbon atom or heteroatom and may include persubstitution of the chemical group.

The term “substitution” means that at least one hydrogen atom (—H) bonded to a carbon atom or heteroatom of a corresponding unsubstituted compound or functional group is replaced by a substituent (e.g. R^{S}). The term “persubstitution” means that every hydrogen atom (H) bonded to a carbon atom or heteroatom of a corresponding unsubstituted compound or functional group is replaced by a substituent (e.g., R^{S}). The term “polysubstitution” means that at least two, but fewer than all, hydrogen atoms bonded to carbon atoms or heteroatoms of a corresponding unsubstituted compound or functional group are replaced by a substituent.

The term “—H” means a hydrogen or hydrogen radical that is covalently bonded to another atom. “Hydrogen” and “—H” are interchangeable, and unless clearly specified mean the same thing.

The term “(C₁-C₄₀)hydrocarbyl” means a hydrocarbon radical of from 1 to 40 carbon atoms and the term “(C₁-C₄₀)hydrocarbylene” means a hydrocarbon diradical of from 1 to 40 carbon atoms, in which each hydrocarbon radical and each hydrocarbon diradical is aromatic or non-aromatic, saturated or unsaturated, straight chain or branched chain, cyclic (including mono- and poly-cyclic, fused and non-fused polycyclic, including bicyclic; 3 carbon atoms or more) or acyclic and is unsubstituted or substituted by one or more R^{S}.

In this disclosure, a (C₁-C₄₀)hydrocarbyl can be an unsubstituted or substituted (C₁-C₄₀)alkyl, (C₃-C₄₀)cycloalkyl, (C₃-C₂₀)cycloalkyl-(C₁-C₂₀)alkylene, (C₆-C₄₀)aryl, or (C₆-C₂₀)aryl-(C₁-C₂₀)alkylene. In some embodiments, each of the aforementioned (C₁-C₄₀)hydrocarbyl groups has a maximum of 20 carbon atoms (i.e., (C₁-C₂₀)hydrocarbyl) and other embodiments, a maximum of 12 carbon atoms.

The terms “(C₁-C₄₀)alkyl” and “(C₁-C₁₈)alkyl” mean a saturated straight or branched hydrocarbon radical of from 1 to 40 carbon atoms or from 1 to 18 carbon atoms, respectively, which is unsubstituted or substituted by one or more R^{S}. Examples of unsubstituted (C₁-C₄₀)alkyl are unsubstituted (C₁-C₂₀)alkyl; unsubstituted (C₁-C₁₀)alkyl; unsubstituted (C₁-C₅)alkyl; methyl; ethyl; 1-propyl; 2-propyl; 1-butyl; 2-butyl; 2-methylpropyl; 1,1-dimethylethyl; 1-pentyl; 1-hexyl; 1-heptyl; 1-nonyl; and 1-decyl. Examples of substituted (C₁-C₄₀)alkyl are substituted (C₁-C₂₀)alkyl, substituted (C₁-C₁₀)alkyl, trifluoromethyl, and [C₄₅]alkyl. The term “[C₄₅]alkyl” (with square brackets) means there is a maximum of 45 carbon atoms in the radical, including substituents, and is, for example, a (C₂₇-C₄₀)alkyl substituted by one R^{S}, which is a (C₁-C₅)alkyl, respectively. Each (C₁-C₅)alkyl may be methyl, trifluoromethyl, ethyl, 1-propyl, 1-methylethyl, or 1,1-dimethylethyl.

The term “(C₆-C₄₀)aryl” means an unsubstituted or substituted (by one or more R^{S}) mono-, bi- or tricyclic aromatic hydrocarbon radical of from 6 to 40 carbon atoms, of which at least from 6 to 14 of the carbon atoms are aromatic ring carbon atoms, and the mono-, bi- or tricyclic radical comprises 1, 2, or 3 rings, respectively; wherein the 1 ring is aromatic and the 2 or 3 rings independently are fused or non-fused and at least one of the 2 or 3 rings is aromatic. Examples of unsubstituted (C₆-C₄₀)aryl are unsubstituted (C₆-C₂₀)aryl unsubstituted (C₆-C₁₈)aryl; 2-(C₁-C₅)alkyl-phenyl; 2,4-bis(C₁-C₅)alkyl-phenyl; phenyl; fluorenyl; tetrahydrofluorenyl; indacenyl; hexahydroindacenyl; indenyl; dihydroindenyl; naphthyl; tetrahydronaphthyl; and phenanthrene. Examples of substituted (C₆-C₄₀)aryl are substituted (C₁-C₂₀)aryl; substituted (C₆-C₁₈)aryl; 2,4-bis[(C₂₀)alkyl]-phenyl; polyfluorophenyl; pentafluorophenyl; and fluoren-9-one-1-yl.

The term “(C₃-C₄₀)cycloalkyl” means a saturated cyclic hydrocarbon radical of from 3 to 40 carbon atoms that is unsubstituted or substituted by one or more R^{S}. Other cycloalkyl groups (e.g., (Cₓ-C_{y})cycloalkyl) are defined in an analogous manner as having from x to y carbon atoms and being either unsubstituted or substituted with one or more R^{S}. Examples of unsubstituted (C₃-C₄₀)cycloalkyl are unsubstituted (C₃-C₂₀)cycloalkyl, unsubstituted (C₃-C₁₀)cycloalkyl, cyclopropyl, cyclobutyl, cyclopentyl, cyclohexyl, cycloheptyl, cyclooctyl, cyclononyl, and cyclodecyl. Examples of substituted (C₃-C₄₀)cycloalkyl are substituted (C₃-C₂₀)cycloalkyl, substituted (C₃-C₁₀)cycloalkyl, cyclopentanon-2-yl, and 1-fluorocyclohexyl.

Examples of (C₁-C₄₀)hydrocarbylene include unsubstituted or substituted (C₆-C₄₀)arylene, (C₃-C₄₀)cycloalkylene, and (C₁-C₄₀)alkylene (e.g., (C₁-C₂₀)alkylene). In some embodiments, the diradicals are on the same carbon atom (e.g., —CH₂—) or on adjacent carbon atoms (i.e., 1,2-diradicals), or are spaced apart by one, two, or more than two intervening carbon atoms (e.g., respective 1,3-diradicals, 1,4-diradicals, etc.). Some diradicals include α,ω-diradical. The α,ω-diradical is a diradical that has maximum carbon backbone spacing between the radical carbons. Some examples of (C₂-C₂₀)alkylene α,ω-diradicals include ethan-1,2-diyl (i.e. —CH₂CH₂—), propan-1,3-diyl (i.e. —CH₂CH₂CH₂—), 2-methylpropan-1,3-diyl (i.e. —CH₂CH(CH₃)CH₂—). Some examples of (C₆-C₄₀)arylene α,ω-diradicals include phenyl-1,4-diyl, napthalen-2,6-diyl, or napthalen-3,7-diyl.

The term “(C₁-C₄₀)alkylene” means a saturated straight chain or branched chain diradical (i.e., the radicals are not on ring atoms) of from 1 to 40 carbon atoms that is unsubstituted or substituted by one or more R^{S}. Examples of unsubstituted (C₁-C₄₀)alkylene are unsubstituted (C₁-C₂₀)alkylene, including unsubstituted —CH₂CH₂—, —(CH₂)₃—, —(CH₂)₄—, —(CH₂)₅—, —(CH₂)₆—, —(CH₂)₇—, —(CH₂)₈—, —CH₂C*HCH₃, and —(CH₂)₄C*(H)(CH₃), in which “C*” denotes a carbon atom from which a hydrogen atom is removed to form a secondary or tertiary alkyl radical. Examples of substituted (C₁-C₄₀)alkylene are substituted (C₁-C₂₀)alkylene, —CF₂—, —C(O)—, and —(CH₂)₁₄C(CH₃)₂(CH₂)₅— (i.e., a 6,6-dimethyl substituted normal-1,20-eicosylene). Since as mentioned previously two R^{S} may be taken together to form a (C₁-C₁₈)alkylene, examples of substituted (C₁-C₄₀)alkylene also include 1,2-bis(methylene)cyclopentane, 1,2-bis(methylene)cyclohexane, 2,3-bis(methylene)-7,7-dimethyl-bicyclo[2.2.1]heptane, and 2,3-bis(methylene)bicyclo [2.2.2]octane.

The term “(C₃-C₄₀)cycloalkylene” means a cyclic diradical (i.e., the radicals are on ring atoms) of from 3 to 40 carbon atoms that is unsubstituted or substituted by one or more R^{S}.

The term “heteroatom,” refers to an atom other than hydrogen or carbon. Examples of groups containing one or more than one heteroatom include O, S, S(O), S(O)₂, Si(R^{C})₂, P(R^{P}), N(R^{N}), N═C(R^{C})₂, —Ge(R^{C})₂—, or —Si(R^{C})—, where each R^{C} and each R^{P} is unsubstituted (C₁-C₁₈)hydrocarbyl or —H, and where each R^{N} is unsubstituted (C₁-C₁₈)hydrocarbyl. The term “heterohydrocarbon” refers to a molecule or molecular framework in which one or more carbon atoms are replaced with a heteroatom. The term “(C₁-C₄₀)heterohydrocarbyl” means a heterohydrocarbon radical of from 1 to 40 carbon atoms, and the term “(C₁-C₄₀)heterohydrocarbylene” means a heterohydrocarbon diradical of from 1 to 40 carbon atoms, and each heterohydrocarbon has one or more heteroatoms. The radical of the heterohydrocarbyl is on a carbon atom or a heteroatom, and diradicals of the heterohydrocarbyl may be on: (1) one or two carbon atom, (2) one or two heteroatoms, or (3) a carbon atom and a heteroatom. Each (C₁-C₄₀)heterohydrocarbyl and (C₁-C₄₀)heterohydrocarbylene may be unsubstituted or substituted (by one or more R^{S}), aromatic or non-aromatic, saturated or unsaturated, straight chain or branched chain, cyclic (including mono- and poly-cyclic, fused and non-fused polycyclic), or acyclic.

The (C₁-C₄₀)heterohydrocarbyl may be unsubstituted or substituted. Non-limiting examples of the (C₁-C₄₀)heterohydrocarbyl include (C₁-C₄₀)heteroalkyl, (C₁-C₄₀)hydrocarbyl-O—, (C₁-C₄₀)hydrocarbyl-S—, (C₁-C₄₀)hydrocarbyl-S(O)—, (C₁-C₄₀)hydrocarbyl-S(O)₂—, (C₁-C₄₀)hydrocarbyl-Si(R^{C})₂—, (C₁-C₄₀)hydrocarbyl-N(R^{N})—, (C₁-C₄₀)hydrocarbyl-P(R^{P})—, (C₂-C₄₀)heterocycloalkyl, (C₂-C₁₉)heterocycloalkyl-(C₁-C₂₀)alkylene, (C₃-C₂₀)cycloalkyl-(C₁-C₁₉)heteroalkylene, (C₂-C₁₉)heterocycloalkyl-(C₁-C₂₀)heteroalkylene, (C₁-C₅₀)heteroaryl, (C₁-C₁₉)heteroaryl-(C₁-C₂₀)alkylene, (C₆-C₂₀)aryl-(C₁-C₁₉)heteroalkylene, or (C₁-C₁₉)heteroaryl-(C₁-C₂₀)heteroalkylene.

The term “(C₁-C₄₀)heteroaryl” means an unsubstituted or substituted (by one or more R^{S}) mono-, bi- or tricyclic heteroaromatic hydrocarbon radical of from 1 to 40 total carbon atoms and from 1 to 10 heteroatoms, and the mono-, bi- or tricyclic radical comprises 1, 2 or 3 rings, respectively, wherein the 2 or 3 rings independently are fused or non-fused and at least one of the 2 or 3 rings is heteroaromatic. Other heteroaryl groups (e.g., (Cₓ-C_{y})heteroaryl generally, such as (C₁-C₁₂)heteroaryl) are defined in an analogous manner as having from x to y carbon atoms (such as 1 to 12 carbon atoms) and being unsubstituted or substituted by one or more than one R^{S}. The monocyclic heteroaromatic hydrocarbon radical is a 5-membered or 6-membered ring. The 5-membered ring has 5 minus h carbon atoms, wherein h is the number of heteroatoms and may be 1, 2, 3, or 4; and each heteroatom may be O, S, N, or P. Examples of 5-membered ring heteroaromatic hydrocarbon radical are pyrrol-1-yl; pyrrol-2-yl; furan-3-yl; thiophen-2-yl; pyrazol-1-yl; isoxazol-2-yl; isothiazol-5-yl; imidazol-2-yl; oxazol-4-yl; thiazol-2-yl; 1,2,4-triazol-1-yl; 1,3,4-oxadiazol-2-yl; 1,3,4-thiadiazol-2-yl; tetrazol-1-yl; tetrazol-2-yl; and tetrazol-5-yl. The 6-membered ring has 6 minus h carbon atoms, wherein h is the number of heteroatoms and may be 1 or 2 and the heteroatoms may be N or P. Examples of 6-membered ring heteroaromatic hydrocarbon radical are pyridine-2-yl; pyrimidin-2-yl; and pyrazin-2-yl. The bicyclic heteroaromatic hydrocarbon radical can be a fused 5,6- or 6,6-ring system. Examples of the fused 5,6-ring system bicyclic heteroaromatic hydrocarbon radical are indol-1-yl; and benzimidazole-1-yl. Examples of the fused 6,6-ring system bicyclic heteroaromatic hydrocarbon radical are quinolin-2-yl; and isoquinolin-1-yl. The tricyclic heteroaromatic hydrocarbon radical can be a fused 5,6,5-; 5,6,6-; 6,5,6-; or 6,6,6-ring system. An example of the fused 5,6,5-ring system is 1,7-dihydropyrrolo[3,2-f]indol-1-yl. An example of the fused 5,6,6-ring system is 1H-benzo[f]indol-1-yl. An example of the fused 6,5,6-ring system is 9H-carbazol-9-yl. An example of the fused 6,6,6-ring system is acrydin-9-yl.

The aforementioned heteroalkyl may be saturated straight or branched chain radicals containing (C₁-C₄₀) carbon atoms, or fewer carbon atoms and one or more of the heteroatoms. Likewise, the heteroalkylene may be saturated straight or branched chain diradicals containing from 1 to 50 carbon atoms and one or more than one heteroatoms. The heteroatoms, as defined above, may include Si(R^{C})₃, Ge(R^{C})₃, Si(R^{C})₂, Ge(R^{C})₂, P(R^{P})₂, P(R^{P}), N(R^{N})₂, N(R^{N}), N, O, OR^{C}, S, SR^{C}, S(O), and S(O)₂, wherein each of the heteroalkyl and heteroalkylene groups are unsubstituted or substituted by one or more R^{S}.

Examples of unsubstituted (C₂-C₄₀)heterocycloalkyl are unsubstituted (C₂-C₂₀)heterocycloalkyl, unsubstituted (C₂-C₁₀)heterocycloalkyl, aziridin-1-yl, oxetan-2-yl, tetrahydrofuran-3-yl, pyrrolidin-1-yl, tetrahydrothiophen-S,S-dioxide-2-yl, morpholin-4-yl, 1,4-dioxan-2-yl, hexahydroazepin-4-yl, 3-oxa-cyclooctyl, 5-thio-cyclononyl, and 2-aza-cyclodecyl.

The term “halogen atom” or “halogen” means the radical of a fluorine atom (F), chlorine atom (Cl), bromine atom (Br), or iodine atom (I). The term “halide” means anionic form of the halogen atom: fluoride (F⁻), chloride (Cl⁻), bromide (Br⁻), or iodide (I⁻).

The term “saturated” means lacking carbon-carbon double bonds, carbon-carbon triple bonds, and (in heteroatom-containing groups) carbon-nitrogen, carbon-phosphorous, and carbon-silicon double bonds. Where a saturated chemical group is substituted by one or more substituents R^{S}, one or more double and/or triple bonds optionally may or may not be present in substituents R^{S}. The term “unsaturated” means containing one or more carbon-carbon double bonds, carbon-carbon triple bonds, and (in heteroatom-containing groups) carbon-nitrogen, carbon-phosphorous, and carbon-silicon double bonds, not including any such double bonds that may be present in substituents R^{S}, if any, or in (hetero) aromatic rings, if any.

In some embodiments the catalyst systems comprising a metal-ligand complex of Formula (I) may be rendered catalytically active by any technique known in the art for activating metal-based catalysts of olefin polymerization reactions. For example, comprising a metal-ligand complex of Formula (I) may be rendered catalytically active by contacting the complex to, or combining the complex with, an activating cocatalyst. Suitable activating cocatalysts for use herein include alkyl aluminums; polymeric or oligomeric alumoxanes (also known as aluminoxanes); neutral Lewis acids; and non-polymeric, non-coordinating, ion-forming compounds (including the use of such compounds under oxidizing conditions). A suitable activating technique is bulk electrolysis. Combinations of one or more of the foregoing activating cocatalysts and techniques are also contemplated. The term “alkyl aluminum” means a monoalkyl aluminum dihydride or monoalkylaluminum dihalide, a dialkyl aluminum hydride or dialkyl aluminum halide, or a trialkylaluminum. Examples of polymeric or oligomeric alumoxanes include methylalumoxane, triisobutylaluminum-modified methylalumoxane, tri-n-octylaluminum-modified, and methylalumoxane isobutylalumoxane.

Lewis acid activators (cocatalysts) include Group 13 metal compounds containing from 1 to 3 (C₁-C₂₀)hydrocarbyl substituents as described herein. In one embodiments, Group 13 metal compounds are tri(hydrocarbyl)-substituted-aluminum, tri(hydrocarbyl)-boron compounds, tri((C₁-C₁₀)alkyl)aluminum, tri((C₆-C₁₈)aryl)boron compounds, and halogenated (including perhalogenated) derivatives thereof. In further embodiments, Group 13 metal compounds are tris(fluoro-substituted phenyl)boranes, tris(pentafluorophenyl)borane. In some embodiments, the activating cocatalyst is a tetrakis((C₁-C₂0)hydrocarbyl borate (e.g. trityl tetrafluoroborate) or a tri((C₁-C₂₀)hydrocarbyl)ammonium tetra((C₁-C₂₀)hydrocarbyl)borane (e.g. bis(octadecyl)methylammonium tetrakis(pentafluorophenyl)borane). As used herein, the term “ammonium” means a nitrogen cation that is a ((C₁-C₂₀)hydrocarbyl)₄N⁺a ((C₁-C₂₀)hydrocarbyl)₃N(H)⁺, a ((C₁-C₂₀)hydrocarbyl)₂N(H)₂⁺, (C₁-C₂₀)hydrocarbylN(H)₃⁺, or N(H)₄⁺, wherein each (C₁-C₂₀)hydrocarbyl, when two or more are present, may be the same or different.

Combinations of neutral Lewis acid activators (cocatalysts) include mixtures comprising a combination of a tri((C₁-C₄)alkyl)aluminum and a halogenated tri((C₆-C₁₈)aryl)boron compound, especially a tris(pentafluorophenyl)borane. Other embodiments are combinations of such neutral Lewis acid mixtures with a polymeric or oligomeric alumoxane, and combinations of a single neutral Lewis acid, especially tris(pentafluorophenyl)borane with a polymeric or oligomeric alumoxane. Ratios of numbers of moles of (metal-ligand complex): (tris(pentafluoro-phenylborane): (alumoxane) [e.g., (Group 4 metal-ligand complex):(tris(pentafluoro-phenylborane):(alumoxane)]are from 1:1:1 to 1:10:30, in other embodiments, from 1:1:1.5 to 1:5:10.

The catalyst system comprising the metal-ligand complex of Formula (I) may be activated to form an active catalyst composition by combination with one or more cocatalysts, for example, a cation forming cocatalyst, a strong Lewis acid, or combinations thereof. Suitable activating cocatalysts include polymeric or oligomeric aluminoxanes, especially methyl aluminoxane, as well as inert, compatible, noncoordinating, ion forming compounds. Exemplary suitable cocatalysts include, but are not limited to: modified methyl aluminoxane (MMAO), bis(hydrogenated tallow alkyl)methyl tetrakis(pentafluorophenyl)borate(1⁻) amine, and combinations thereof.

In some embodiments, one or more of the foregoing activating cocatalysts are used in combination with each other. An especially preferred combination is a mixture of a tri((C₁-C₄)hydrocarbyl)aluminum, tri((C₁-C₄)hydrocarbyl)borane, or an ammonium borate with an oligomeric or polymeric alumoxane compound. The ratio of total number of moles of one or more metal-ligand complexes of Formula (I) to total number of moles of one or more of the activating cocatalysts is from 1:10,000 to 100:1. In some embodiments, the ratio is at least 1:5000, in some other embodiments, at least 1:1000; and 10:1 or less, and in some other embodiments, 1:1 or less. When an alumoxane alone is used as the activating cocatalyst, preferably the number of moles of the alumoxane that are employed is at least 40 times the number of moles of the metal-ligand complex of Formula (I). When tris(pentafluorophenyl)borane alone is used as the activating cocatalyst, in some other embodiments, the number of moles of the tris(pentafluorophenyl)borane that are employed to the total number of moles of one or more metal-ligand complexes of Formula (I) from 0.5:1 to 10:1, from 1:1 to 6:1, or from 1:1 to 5:1. The remaining activating cocatalysts are generally employed in approximately mole quantities equal to the total mole quantities of one or more metal-ligand complexes of Formula (I).

Various solvents are contemplated, for example, aromatic and paraffin solvents. Exemplary solvents include, but are not limited to, isoparaffins. For example, such isoparaffin solvents are commercially available under the name ISOPAR E from ExxonMobil Chemical.

The reactivity ratios are determined by the resulting difference in polymerization rates (i.e., selectivity) between ethylene and the C₃-C₁₂ α-olefin comonomer with the polymerization catalyst in the polymerization process. It is believed that steric interactions for the polymerization catalysts result in polymerization of ethylene more selectively than α-olefins such as C₃-C₁₂ α-olefins (i.e., the catalyst preferentially polymerizes ethylene in the presence of the α-olefin). Again without being bound by theory, it is believed that such steric interactions cause the catalyst, for example, the homogenous catalyst prepared with or from the metal-ligand complex of Formula (I) to adopt a conformation that allows ethylene to access the M substantially more easily, or adopt a reactive conformation more readily, or both than the catalyst allows the α-olefin to do so.

For random copolymers in which the identity of the last monomer inserted dictates the rate at which subsequent monomers insert, the terminal copolymerization model is employed. In this model insertion reactions of the type

$$⋯ {M}_{i} C * + {M}_{j} {⟶}^{{k}_{ij}} ⋯ {M}_{i} {M}_{j} C * \qquad ( Equation A )$$

where C* represents the catalyst, Mᵢ represents monomer i, and kᵢⱼ is the rate constant having the rate equation as follows.

$${R}_{{p}_{ij}} = {k}_{ij} ⌊ ⋯ {M}_{i} C * ⌋ [ {M}_{j} ] \qquad ( Equation B )$$

The comonomer mole fraction (i=2) in the reaction media is defined by the equation:

$${f}_{2} = \frac{[ {M}_{2} ]}{[ {M}_{1} ] + [ {M}_{2} ]} \qquad ( Equation C )$$

A simplified equation for comonomer composition can be derived as disclosed in George Odian, Principles of Polymerization, Second Edition, John Wiley and Sons, 1970, as follows:

$${F}_{1} = 1 - {F}_{2} = \frac{{{r}_{1} ( 1 - {f}_{2} )}^{2} + ( 1 - {f}_{2} ) {f}_{2}}{{{r}_{1} ( 1 - {f}_{2} )}^{2} + 2 ( 1 - {f}_{2} ) {f}_{2} + {r}_{2} {f}_{2}^{2}} \qquad ( Equation D )$$

From this equation the mole fraction of comonomer in the polymer is solely dependent on the mole fraction of comonomer in the reaction media and two temperature dependent reactivity ratios defined in terms of the insertion rate constants as:

$${r}_{1} = \frac{{k}_{11}}{{k}_{12}} {r}_{2} = \frac{{k}_{22}}{{k}_{21}} \qquad ( Equation E )$$

For this model as well the polymer composition is a function only of temperature dependent reactivity ratios and comonomer mole fraction in the reactor. The same is also true when reverse comonomer or monomer insertion may occur or in the case of the interpolymerization of more than two monomers.

Reactivity ratios for use in the foregoing models may be predicted using well known theoretical techniques or empirically derived from actual polymerization data. Suitable theoretical techniques are disclosed, for example, in B. G. Kyle, Chemical and Process Thermodynamics, Third Addition, Prentice-Hall, 1999 and in Redlich-Kwong-Soave (RKS) Equation of State, Chemical Engineering Science, 1972, pp 1197-1203. Commercially available software programs may be used to assist in deriving reactivity ratios from experimentally derived data. One example of such software is Aspen Plus from Aspen Technology, Inc., Ten Canal Park, Cambridge, MA 02141-2201 USA.

### Films

The polyethylene composition according to embodiments disclosed herein may be incorporated into films. In some embodiments, such films are biaxially oriented. Such films are biaxially oriented using a tenter frame in some embodiments. In some embodiments, such films are uniaxially oriented in the machine direction. In some embodiments, a uniaxially oriented film comprises the polyethylene composition disclosed herein. The oriented, films utilize in at least one layer a polyethylene composition that can advantageously expand the operating window for stretching the films. For example, by expanding the operating window for biaxial orientation, the polyethylene composition can be oriented which can lead to improved film stiffness. The oriented films, in some embodiments, can be used in packaging applications and can be used as lidding or label films.

In one aspect, a biaxially oriented film comprises at least one layer comprising a polyethylene composition that comprises:
(a) from 15 to 25 percent by weight of a first polyethylene component having a molecular weight (Mw) of greater than 200,000 g/mol and a density of from 0.925 to 0.945 g/cc;
(b) from 20 to 35 percent by weight of a second polyethylene component having a molecular weight (Mw) of less than 80,000 g/mol and a density of from 0.915 to 0.950 g/cc; and
(c) from 40 to 65 percent by weight of a third polyethylene component having a molecular weight (Mw) of less than 100,000 g/mol and a density of from 0.940 to 0.965 g/cc; and
wherein the polyethylene composition has a density of from 0.935 to 0.958 g/cc, a melt index (I₂) of from 0.5 to 5.0 g/10 min, and satisfies the following equation:

First Polyethylene Component Weight Fraction*SCB_{log Mw4-5}*Mz (conv. GPC)>230,000.

In some embodiments, the biaxially oriented film is a multilayer film. The number of layers in the film can depend on a number of factors including, for example, the desired properties of the film, the desired thickness of the film, the content of the other layers of the film, the end use application of the film, the equipment available to manufacture the film, and others. For example, a multilayer film can further comprise other layers typically included in multilayer films depending on the application including, for example, sealant layers, barrier layers, tie layers, structural layers, etc. A multilayer film can comprise up to 2, 3, 4, 5, 6, 7, 8, 9, 10, or 11 layers in various embodiments.

Other layers within a multilayer film of the present invention can comprise, in various embodiments, a polymer selected from the following: the polyethylene composition described herein, a LLDPE, a MDPE, a LDPE, a HDPE, a HMWHDPE (a high molecular weight HDPE), a propylene-based polymer, a polyolefin plastomer (POP), a polyolefin elastomer (POE), an olefin block copolymer (OBC), an ethylene vinyl acetate, an ethylene acrylic acid, an ethylene methacrylic acid, an ethylene methyl acrylate, an ethylene ethyl acrylate, an ethylene butyl acrylate, an isobutylene, a maleic anhydride-grafted polyolefin, an ionomer of any of the foregoing, or a combination thereof.

In some embodiments, the biaxially oriented film is oriented in the machine direction at a draw ratio from 2:1 to 9:1 and in the cross direction at a draw ratio from 2:1 to 11:1. The biaxially oriented film, in some embodiments, is oriented in the machine direction at a draw ratio from 2:1 to 6:1 and in the cross direction at a draw ratio from 2:1 to 9:1. In some embodiments, the biaxially oriented film is oriented in the machine direction at a draw ratio from 4:1 to 6:1 and in the cross direction at a draw ratio from 6:1 to 9:1.

In some embodiments, the biaxially oriented film has a thickness of 5 to 50 microns.

In some embodiments, the biaxially oriented film further comprises an outer layer that is a sealant layer.

The biaxially oriented film disclosed herein can have desirable properties. For example, in some embodiments, the biaxially oriented film has at least one of the following: a haze value of less than 15 percent; a 2 percent secant modulus in the machine direction of at least 600 MPa; a 2 percent secant modulus in the cross direction of at least 900 MPa; a clarity of at least 35 percent; a machine direction tensile strain at break of at least 160%; and a cross direction tensile strain at break of at least 20%.

In another aspect, the present invention relates to articles, such as food packages. In one aspect, an article comprises any of the inventive polyethylene compositions disclosed herein.

In another aspect, the present invention relates to laminates and articles formed from such laminates. In some embodiments, a laminate comprises a first film comprising a polyethylene sealant film, polypropylene, or polyamide; and the biaxially oriented film according to any of the embodiments disclosed herein, wherein the first film is laminated to the biaxially oriented film. In one aspect, an article comprises any of the laminates disclosed herein.

In another aspect, the present invention relates to a uniaxially oriented film that comprises at least one layer comprising that comprises a polyethylene composition comprising:
(a) from 15 to 25 percent by weight of a first polyethylene component having a molecular weight (Mw) of greater than 200,000 g/mol and a density of from 0.925 to 0.945 g/cc;
(b) from 20 to 35 percent by weight of a second polyethylene component having a molecular weight (Mw) of less than 80,000 g/mol and a density of from 0.915 to 0.950 g/cc; and
(c) from 40 to 65 percent by weight of a third polyethylene component having a molecular weight (Mw) of less than 100,000 g/mol and a density of from 0.940 to 0.965 g/cc; and
wherein the polyethylene composition has a density of from 0.935 to 0.958 g/cc, a melt index (I₂) of from 0.5 to 5.0 g/10 min, and satisfies the following equation:

First Polyethylene Component Weight Fraction*SCB_{log Mw4-5}*Mz (conv. GPC)>230,000.

In some embodiments, the uniaxially oriented film is oriented in the machine direction at a draw ratio from 4:1 to 20:1. The uniaxially oriented film, in some embodiments, is oriented in the machine direction at a draw ratio from 4:1 to 16:1. In some embodiments, the uniaxially oriented film is oriented in the machine direction at a draw ratio from 4:1 to 12:1. In some embodiments, the uniaxially oriented film is oriented in the machine direction at a draw ratio from 4:1 to 10:1. In some embodiments, the uniaxially oriented film is oriented in the machine direction at a draw ratio from 4:1 to 9:1.

It should be understood that, in some embodiments, any of the layers within the film can further comprise one or more additives (in addition to those described above for the polyethylene-based composition) as known to those of skill in the art such as, for example, antioxidants, ultraviolet light stabilizers, thermal stabilizers, slip agents, antiblock, pigments or colorants, processing aids, crosslinking catalysts, flame retardants, fillers and foaming agents.

By being polyethylene-based, the inventive polyethylene composition, according to some embodiments of the present invention, can be incorporated into multilayer films and articles that are comprised primarily, if not substantially or entirely, of polyethylene in order to provide a film and articles that is more easily recyclable. For example, a film that comprises primarily polyethylene has an improved recyclability profile in addition to other advantages that the usage of such polymers may provide. For example, in some embodiments, other than additives, the oriented film is comprised entirely of ethylene-based polymers. Based on the total weight of the oriented film, the oriented film may include 90% by weight ethylene-based polymer in some embodiments, or 95% by weight ethylene-based polymer in some embodiments, or 99% by weight ethylene-based polymer in some embodiments, or 99.9% by weight ethylene-based polymer in some embodiments, or 100% by weight ethylene-based polymer in some embodiments.

Biaxially oriented films, prior to orientation, can have a variety of thicknesses depending, for example, on the number of layers, the intended use of the film, and other factors. Such polyethylene films, in some embodiments, have a thickness prior to orientation of 320 to 3200 microns (typically, 640-1920 microns).

Prior to orientation, the films can be formed using techniques known to those of skill in the art based on the teachings herein. For example, the films can be prepared as blown films (e.g., water quenched blown films) or cast films. For example, in the case of multilayer polyethylene films, for those layers that can be coextruded, such layers can be coextruded as blown films or cast films using techniques known to those of skill in the art based on the teachings herein.

In various embodiments, the film can be uniaxially oriented or biaxially oriented using techniques known to those having ordinary skill in the art.

In some embodiments where the film is biaxially oriented, the film is biaxially oriented using a tenter frame sequential biaxial orientation process. Such techniques are generally known to those of skill in the art. In other embodiments, the film can be biaxially oriented using other techniques known to those of skill in the art based on the teachings herein, such as double bubble orientation processes. In general, with a tenter frame sequential biaxial orientation process, the tenter frame is incorporated as part of a multilayer co-extrusion line. After extruding from a flat die, the film is cooled down on a chill roll, and is immersed into a water bath filled with room temperature water. The cast film is then passed onto a series of rollers with different revolving speeds to achieve stretching in the machine direction. There are several pairs of rollers in the MD stretching segment of the fabrication line, and are all oil heated. The paired rollers work sequentially as pre-heated rollers, stretching rollers, and rollers for relaxing and annealing. The temperature of each pair of rollers is separately controlled. After stretching in the machine direction, the film web is passed into a tenter frame hot air oven with heating zones to carry out stretching in the cross direction. The first several zones are for pre-heating, followed by zones for stretching, and then the last zones for annealing.

In some embodiments when the multilayer film is uniaxially oriented, the film is oriented in the machine direction only. Various processing parameters are considered suitable for stretching in the machine direction as known to those having ordinary skill in the art based on the teachings herein. For example, the uniaxially oriented, multilayer film may be oriented in the machine direction at a draw ratio greater than 1:1 and less than 8:1, or at a draw ratio from 4:1 to 8:1.

After orientation, the machine direction oriented film has a thickness of 5 to 50 microns in some embodiments. In some embodiments, the machine direction oriented film has a thickness of 15 to 40 microns.

In some embodiments, depending for example on the end use application, the oriented film can be corona treated, plasma treated, or printed using techniques known to those of skill in the art. In some embodiments, the oriented multilayer film can be surface coated with aluminum, silicon oxide, aluminum oxide, or other metals known to those having ordinary skill in the art based on the teachings herein.

### Laminates

Embodiments of the present invention also comprise laminates incorporating oriented films. In some embodiments, a biaxially oriented film according to embodiments of the present invention can be laminated to another film. In some embodiments, a uniaxially oriented (e.g., machine direction oriented), multilayer polyethylene film according to embodiments of the present invention can be laminated to another film.

Laminates according to embodiments of the present invention can be formed using techniques known to those having ordinary skill in the art based on the teachings herein. For example, the oriented, multilayer polyethylene film can be laminated to the other film using an adhesive. Various adhesive compositions are considered suitable for the adhesives used to make a laminate. These may include polyurethane, epoxy, acrylic, or the like. In one embodiment, the laminate may comprise adhesive layers comprising polyurethane adhesive. The polyurethane adhesive may be solventless, waterborne or solvent based. Furthermore, the polyurethane adhesive may be a two part formulation. The weight or thickness of the adhesive layer can depend on a number of factors including, for example, the desired thickness of the multilayer structure, the type of adhesive used, and other factors. In some embodiments, the adhesive layer is applied at up to 5.0 grams/m², or from 1.0 to 4.0 g/m², or from 2.0 to 3.0 g/m².

Laminates according to some embodiments of the present invention can also be formed by extrusion lamination.

### Articles

Embodiments of the present invention also relate to articles, such as packages, formed from or incorporating oriented, multilayer polyethylene films of the present invention (or from laminates incorporating such films). Such packages can be formed from any of the films or laminates described herein.

Examples of such articles can include flexible packages, pouches, stand-up pouches, and pre-made packages or pouches. In some embodiments, oriented, multilayer polyethylene films or laminates of the present invention can be used for food packages. Examples of food that can be included in such packages include meats, cheeses, cereal, nuts, juices, sauces, and others. Such packages can be formed using techniques known to those of skill in the art based on the teachings herein and based on the particular use for the package (e.g., type of food, amount of food, etc.).

### Test Methods

The testing methods include the following:
Melt Index (I₂) and (I₁₀)

Melt index (I₂) values are measured in accordance to ASTM D1238 at 190° C. at 2.16 kg. Similarly, melt index (ho) values are measured in accordance to ASTM D1238 at 190° C. at 10 kg. The values are reported in g/10 min, which corresponds to grams eluted per 10 minutes. These data are collected for the overall polyethylene compositions and reported in Table 2 and Table 3. The melt index (I₂) values for the first polyethylene component, the second polyethylene component, and the third polyethylene component are calculated according to Equation 17 and the deconvolution methodology described below and are shown in Table 4.

### Density

Density measurements are made to the overall polyethylene composition in accordance with ASTM D792, Method B. The data are reported in Table 2 and Table 3. For the first and second polyethylene components, the density values are obtained using Equations 15 and the deconvolution methodology described below. For the third polyethylene component, the density value is calculated using Equation 16. Density is reported in grams per cubic centimeter (g/cc or g/cm³). The individual component density data are reported in Table 4.

### Conventional (Conv.) Gel Permeation Chromatography (GPC)

The chromatographic system consisted of a PolymerChar GPC-IR (Valencia, Spain) high temperature GPC chromatograph equipped with an internal IR5 infra-red detector (IR5). The autosampler oven compartment was set at 1600 Celsius and the column compartment was set at 150° Celsius. The columns used were 4 Agilent “Mixed A” 30 cm 20-micron linear mixed-bed columns. The chromatographic solvent used was 1,2,4 trichlorobenzene and contained 200 ppm of butylated hydroxytoluene (BHT). The solvent source was nitrogen sparged. The injection volume used was 200 microliters and the flow rate was 1.0 milliliters/minute.

Calibration of the GPC column set was performed with 21 narrow molecular weight distribution polystyrene standards with molecular weights ranging from 580 to 8,400,000 and were arranged in 6 “cocktail” mixtures with at least a decade of separation between individual molecular weights. The standards were purchased from Agilent Technologies. The polystyrene standards were prepared at 0.025 grams in 50 milliliters of solvent for molecular weights equal to or greater than 1,000,000, and 0.05 grams in 50 milliliters of solvent for molecular weights less than 1,000,000. The polystyrene standards were pre-dissolved at 80° C. with gentle agitation for 30 minutes then cooled and the room temperature solution is transferred cooled into the autosampler dissolution oven at 160° C. for 30 minutes. The polystyrene standard peak molecular weights were converted to polyethylene molecular weights using Equation 1 (as described in Williams and Ward, J. Polym. Sci., Polym. Let., 6, 621 (1968)).:

$${M}_{polyethylene} = A \times {( {M}_{polystyrene} )}^{B} \qquad ( EQ 1 )$$

where M is the molecular weight, A has a value of 0.4129 and B is equal to 1.0.

A fifth order polynomial was used to fit the respective polyethylene-equivalent calibration points. The total plate count of the GPC column set was performed with decane which was introduced into blank sample via a micropump controlled with the PolymerChar GPC-IR system. The plate count for the chromatographic system should be greater than 18,000 for the 4 Agilent “Mixed A” 30 cm 20-micron linear mixed-bed columns.

Samples were prepared in a semi-automatic manner with the PolymerChar “Instrument Control” Software, wherein the samples were weight-targeted at 2 mg/ml, and the solvent (contained 200 ppm BHT) was added to a pre nitrogen-sparged septa-capped vial, via the PolymerChar high temperature autosampler. The samples were dissolved for 2 hours at 1600 Celsius under “low speed” shaking.

The calculations of Mn_{(GPC)}, Mw_{(GPC)}, and Mz_{(GPC)} were based on GPC results using the internal IR5 detector (measurement channel) of the PolymerChar GPC-IR chromatograph according to Equations 2-4, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1.

$${Mn}_{( GPC )} = \frac{{\sum }^{i} {IR}_{i}}{{\sum }^{i} ( I {R}_{i} / {M}_{{polyethylene}_{i}} )} \qquad ( EQ 2 )$$

$${Mw}_{( GPC )} = \frac{{\sum }^{i} ( I {R}_{i} * {M}_{{polyethylene}_{i}} )}{{\sum }^{i} {IR}_{i}} \qquad ( EQ 3 )$$

$${Mz}_{( GPC )} = \frac{{\sum }^{i} ( I {R}_{i} * {M}_{{polyethylene}_{i}}^{2} )}{{\sum }^{i} ( I {R}_{i} * {M}_{{polyethylene}_{i}} )} \qquad ( EQ 4 )$$

In order to monitor the deviations over time, a flowrate marker (decane) was introduced into each sample via a micropump controlled with the PolymerChar GPC-IR system. This flowrate marker (FM) was used to linearly correct the pump flowrate (Flowrate(nominal)) for each sample by RV alignment of the respective decane peak within the sample (RV(FM Sample)) to that of the decane peak within the narrow standards calibration (RV(FM Calibrated)). Any changes in the time of the decane marker peak are then assumed to be related to a linear-shift in flowrate (Flowrate(effective)) for the entire run. After calibrating the system based on a flow marker peak, the effective flowrate (with respect to the narrow standards calibration) is calculated as Equation 5. Processing of the flow marker peak was done via the PolymerChar GPCOne™ Software. Acceptable flowrate correction is such that the effective flowrate should be within +/−0.5% of the nominal flowrate.

$$Flowrate ( effective ) = Flowrate ( nominal ) * ( RV ( FM Calibrated ) / RV ( FM Sample ) ) \qquad ( EQ 5 )$$

GPC measurements are done on both the overall polyethylene composition and the polymer sampled from the first reactor containing the first and second polyethylene components.

Improved Method for Comonomer Content Analysis (iCCD)

Improved method for comonomer content analysis (iCCD) was developed in 2015 (Cong and Parrott et al., WO2017040127A1). iCCD test was performed with Crystallization Elution Fractionation instrumentation (CEF) (PolymerChar, Spain) equipped with IR-5 detector (PolymerChar, Spain) and two angle light scattering detector Model 2040 (Precision Detectors, currently Agilent Technologies). A guard column packed with 20-27-micron glass (MoSCi Corporation, USA) in a 5 cm or 10 cm (length)X1/4″ (ID) stainless was installed just before IR-5 detector in the detector oven. Ortho-dichlorobenzene (ODCB, 99% anhydrous grade or technical grade) was used. Silica gel 40 (particle size 0.2~0.5 mm, catalogue number 10181-3) from EMD Chemicals was obtained (can be used to dry ODCB solvent before). Dried silica was packed into three emptied HT-GPC columns to further purify ODCB as eluent. The CEF instrument is equipped with an autosampler with N2 purging capability. ODCB is sparged with dried nitrogen (N2) for one hour before use. Sample preparation was done with autosampler at 4 mg/ml (unless otherwise specified) under shaking at 160° C. for 1 hour. The injection volume was 300 μl. The temperature profile of iCCD was crystallization at 3° C./min from 105° C. to 30° C., the thermal equilibrium at 30° C. for 2 minute (including Soluble Fraction Elution Time being set as 2 minutes), elution at 3° C./min from 30° C. to 140° C. The flow rate during crystallization is 0.0 ml/min. The flow rate during elution is 0.50 ml/min. The data was collected at one data point/second.

The iCCD column was packed with gold coated nickel particles (Bright 7GNM8-NiS, Nippon Chemical Industrial Co.) in a 15 cm (length)X1/4″ (ID) stainless tubing. The column packing and conditioning were with a slurry method according to the reference (Cong, R.; Parrott, A.; Hollis, C.; Cheatham, M. WO2017040127A1). The final pressure with TCB slurry packing was 150 Bars.

Column temperature calibration was performed by using a mixture of the Reference Material Linear homopolymer polyethylene (having zero comonomer content, Melt index (I2) of 1.0, polydispersity Mw/Mn approximately 2.6 by conventional gel permeation chromatography, 1.0 mg/ml) and Eicosane (2 mg/ml) in ODCB. iCCD temperature calibration consisted of four steps: (1) Calculating the delay volume defined as the temperature offset between the measured peak elution temperature of Eicosane minus 30.00° C.; (2) Subtracting the temperature offset of the elution temperature from iCCD raw temperature data. It is noted that this temperature offset is a function of experimental conditions, such as elution temperature, elution flow rate, etc.; (3) Creating a linear calibration line transforming the elution temperature across a range of 30.00° C. and 140.00° C. so that the linear homopolymer polyethylene reference had a peak temperature at 101.0° C., and Eicosane had a peak temperature of 30.0° C.; (4) For the soluble fraction measured isothermally at 30° C., the elution temperature below 30.0° C. is extrapolated linearly by using the elution heating rate of 3° C./min according to the reference (Cerk and Cong et al., U.S. Pat. No. 9,688,795).

The comonomer content versus elution temperature of iCCD was constructed by using 12 reference materials (ethylene homopolymer and ethylene-octene random copolymer made with single site metallocene catalyst, having ethylene equivalent weight average molecular weight ranging from 35,000 to 128,000). All of these reference materials were analyzed same way as specified previously at 4 mg/mL. The reported elution peak temperatures followed the figure of octene mole % versus elution temperature of iCCD at R2 of 0.978.

Molecular weight of polymer and the molecular weight of the polymer fractions was determined directly from LS detector (90 degree angle) and concentration detector (IR-5) according Rayleigh-Gans-Debys approximation (Striegel and Yau, Modem Size Exclusion Liquid Chromatogram, Page 242 and Page 263) by assuming the form factor of 1 and all the virial coefficients equal to zero. Integration windows are set to integrate all the chromatograms in the elution temperature (temperature calibration is specified above) range from 23.0 to 120° C.

The calculation of Molecular Weight (Mw) from iCCD includes the following steps: Measuring the interdetector offset. The offset is defined as the geometric volume offset between LS with respect to concentration detector. It is calculated as the difference in the elution volume (mL) of polymer peak between concentration detector and LS chromatograms. It is converted to the temperature offset by using elution thermal rate and elution flow rate. A linear high density polyethylene (having zero comonomer content, Melt index (I2) of 1.0, polydispersity Mw/Mn approximately 2.6 by conventional gel permeation chromatography) is used. Same experimental conditions as the normal iCCD method above are used except the following parameters: crystallization at 10° C./min from 140° C. to 137° C., the thermal equilibrium at 137° C. for 1 minute as Soluble Fraction Elution Time, soluble fraction (SF) time of 7 minutes, elution at 3° C./min from 137° C. to 142° C. The flow rate during crystallization is 0.0 ml/min. The flow rate during elution is 0.80 ml/min. Sample concentration is 1.0 mg/ml. Each LS datapoint in LS chromatogram is shifted to correct for the interdetector offset before integration. Baseline subtracted LS and concentration chromatograms are integrated for the whole eluting temperature range of the Step (1). The MW detector constant is calculated by using a known MW HDPE sample in the range of 100,000 to 140,000 Mw and the area ratio of the LS and concentration integrated signals. Mw of the polymer was calculated by using the ratio of integrated light scattering detector (90 degree angle) to the concentration detector and using the MW detector constant.

The molecular weight calculations and calibrations were performed in GPCOne® software.

iCCD measurements are done on both the overall polyethylene composition and the polymer sampled from the first reactor containing the first and second polyethylene components.

### Numerical Deconvolution of Bivariate Data

Numerical Deconvolution of Bivariate Data is used to obtain the density, molecular weight (Mw), and melt index (I₂) of the first polyethylene component, the second polyethylene component, and the third polyethylene component. Numerical deconvolution of the combined iCCD-SCBD (wt_{iCCD}(T) vs. temperature (T) plot from iCCD) and GPC-MWD (wt_{GPC}(lgMW)) vs. lgMW plot from conventional GPC) data was performed using Microsoft Excel® Solver (2018). For iCCD-SCBD, the calculated weight fraction (wt_{sum,iCCD}(T)) versus temperature (T) data obtained using the method described in the iCCD section (in the range of approximately 23 to 120° C.) was quelled to approximately 200 equally-spaced data points in order for a balance of appropriate iterative speed and temperature resolution. A single or series (up to 3 peaks for each component) of Exponentially-Modified Gaussian Distributions (Equation 6) were summed to represent each component (wt_{C,iCCD}(T)), and the components were summed to yield the total weight (wt_{sum,iCCD}(T)) at any temperature (T) as shown in Equation 7A-D.

$${y}_{T , C , P} = \frac{{a}_{0 , C , P}}{2 {a}_{3 , C , P}} {e}^{( \frac{{a}_{2 , C , P}^{2}}{2 {a}_{3 , C , P}^{2}} + \frac{{a}_{1 , C , P} - T}{{a}_{3 , C , P}} )} [ \frac{1}{2} + \frac{1}{2} erf ( \frac{T - {a}_{1 , C , P}}{\sqrt{2} {a}_{2 , C , P}} - \frac{{a}_{2 , C , P}}{\sqrt{2} {a}_{3 , C , P}} ) ] \qquad ( Equation 6 )$$

where C means component (C=1, 2 or 3), P means peak (P=1, 2, or 3), a_{0,C,P} is the chromatographic area in ° C. for the P-th peak of the C-th component, a_{1,C,P} is the peak center in ° C. for the P-th peak of the C-th component, a_{2,C,P} is the peak width in ° C. for the P-th peak of the C-th component, a_{3,C,P} is the peak tailing in ° C. for the P-th peak of the C-th component, and T is the elution temperature in ° C. In the case of a single Exponentially-Modified Gaussian Distributions is used to represent the iCCD-SCBD of a component, y_{T,C,2}=y_{T,C,3}=0. In the case of two Exponentially-Modified Gaussian Distributions are used to represent the iCCD-SCBD of a component, only y_{T,C,3}=0.

$$w {t}_{C 1 , iCCD} ( T ) = {\sum }_{p = 1}^{3} {y}_{T , 1 , P} \qquad ( Equation 7 A )$$

$$w {t}_{C 2 , i C C D} ( T ) = {\sum }_{p = 1}^{3} {y}_{T , 2 , P} \qquad ( Equation 7 B )$$

$$w {t}_{C 3 , i C C D} ( T ) = {\sum }_{p = 1}^{3} {y}_{T , 3 , P} \qquad ( Equation 7 C )$$

$${wt}_{sum , iCCD} ( T ) = w {t}_{C 1 , i C C D} ( T ) + w {t}_{C 2 , i C C D} ( T ) + w {t}_{C 3 , i C C D} ( T ) \qquad ( Equation 7 D )$$

Weight fraction of each component (wf_{C,iCCD}) from iCCD-SCBD deconvolution can be expressed by

$$w {f}_{C 1 , iCCD} = \int {wt}_{C 1} ( T ) dT \qquad ( Equation 8 A )$$

$$w {f}_{C 2 , iCCD} = \int w {t}_{C 2} ( T ) d T \qquad ( Equation 8 B )$$

$$w {f}_{C 3 , iCCD} = \int w {t}_{C 3} ( T ) d T \qquad ( Equation 8 C )$$

$$\int w {t}_{sum , iCCD} ( T ) dT = 1.00 \qquad ( Equation 8 D )$$

where wf_{C1,iCCD} is the weight fraction of the first polyethylene component obtained from iCCD-SCBD deconvolution, wf_{C2,iCCD} is the weight fraction of the second polyethylene component obtained from iCCD-SCBD deconvolution, wf_{C3,iCCD} is the weight fraction of the third polyethylene component obtained from iCCD-SCBD deconvolution, and the sum of the fractions is normalized to 1.00.

For GPC-MWD, the MWD obtained by the Conventional GPC description section was imported into the same spreadsheet in 0.01 lg(MW/(g/mol)) increments between 2.00 and 7.00 (501 data points total). A Flory-Schulz Distribution with a weight-average molecular weight of M_{w,Target} and a polydispersity (M_{w}/Mₙ) of 2.0 is shown in the following equations.

$${wt}_{F - S , i} = {( \frac{3.03485 \times {M}_{i}}{{M}_{w , Target}} )}^{2} \times {e}^{( \frac{- 2 {M}_{i}}{{M}_{w , Target}} )} \qquad ( Equation 9 )$$

$${\sum }_{i = 0}^{499} w {t}_{F - S , i} \times ( lg ( {M}_{i + 1} / ( g / mol ) ) - lg ( {M}_{i} / ( g / mol ) ) ) = 1.00 \qquad ( Equation 10 )$$

$$lg ( {M}_{i + 1} / ( g / mol ) ) - lg ( {M}_{i} / ( g / mol ) ) = 0.01 \qquad ( Equation 11 )$$

where wt_{F-S,i} is the weigh fraction of the molecules at lg(Mᵢ/(g/mol)) (Mᵢ in g/mol), i is integers ranging from 0 to 500 to represent each data point on the GPC-MWD plot and corresponding lg(Mᵢ/(g/mol)) is 2+0.01×i.

The Flory-Schulz Distribution is subsequently broadened using a sum of a series normal distribution at each lg(Mᵢ/(g/mol)). The weight fraction of the Normal Distribution with its peak value at lg(Mᵢ/(g/mol)) is kept the same as the original Flory-Schulz Distribution. The broadened Flory-Schulz Distribution curve can be described as the following equation.

$$w {t}_{G P C} ( l g ( {M}_{i} / ( g / mol ) ) ) = {\sum }_{j = 0}^{500} \frac{w {t}_{F - S , j}}{\sqrt{2 π} σ} {e}^{- \frac{{( lg ( {M}_{i} / ( g / mol ) ) - ( 2 + 0.01 \times j ) )}^{2}}{2 {σ}^{2}}} \qquad ( Equation 12 )$$

where wt_{GPC}(lg(Mᵢ/(g/mol))) is the weight fraction of the molecules at lg(Mᵢ/(g/mol)), j is integers ranging from 0 to 500, σ is the standard deviation of the Normal Distribution. Therefore, molecular weight distribution curves for all three components can be expressed as the following equations. Number-average molecular weight (M_{n(GPC)}), weight-average molecular weight (M_{w(GPC)}), and MWD (M_{w(GPC)}/M_{n(GPC)}) can be calculated from the broadened Flory-Schulz Distribution.

$${wt}_{C 1 , GPC} ( lg ( {M}_{i} / ( g / mol ) ) ) = w {f}_{C 1 , GPC} \times {\sum }_{j = 0}^{500} \frac{w {t}_{F - S , C 1 , j}}{\sqrt{2 π} {σ}_{C 1}} {e}^{- \frac{{( lg ( {M}_{i} / ( g / mol ) ) - ( 2 + 0.01 \times j ) )}^{2}}{2 {σ}_{C 1}^{2}}} \qquad ( Equation 13 A )$$

$${wt}_{C 2 , GPC} ( lg ( {M}_{i} / ( g / mol ) ) ) = w {f}_{C 2 , GPC} \times {\sum }_{j = 0}^{500} \frac{w {t}_{F - S , C 2 , j}}{\sqrt{2 π} {σ}_{C 2}} {e}^{- \frac{{( lg ( {M}_{i} / ( g / mol ) ) - ( 2 + 0.01 \times j ) )}^{2}}{2 {σ}_{C 2}^{2}}} \qquad ( Equation 13 B )$$

$${wt}_{C 3 , GPC} ( lg ( {M}_{i} / ( g / mol ) ) ) = {wt}_{C 3 , GPC} \times {\sum }_{j = 0}^{500} \frac{w {t}_{F - S , C 3 , j}}{\sqrt{2 π} {σ}_{C 3}} {e}^{- \frac{{( lg ( {M}_{i} / ( g / mol ) ) - ( 2 + 0.01 \times j ) )}^{2}}{2 {σ}_{C 3}^{2}}} \qquad ( Equation 13 C )$$

$${wt}_{s u m , G P C} ( l g ( {M}_{i} / ( g / mol ) ) ) = w {t}_{C 1 , G P C} ( l g ( {M}_{i} / ( g / mol ) ) ) + {wt}_{C 2 , GPC} ( l g ( {M}_{i} / ( g / mol ) ) ) + w {t}_{C 3 , GPC} ( l g ( {M}_{i} / ( g / mol ) ) ) \qquad ( Equation 13 D )$$

where σ is the normal distribution width parameter, the subscripts C1, C2 and C3 represent the first, the second and the third polyethylene components, respectively. wf_{C1,GPC}, wf_{C2,GPC} and wf_{C3,GPC} are the weight fractions of the first, the second and the third polyethylene components from GPC-MWD, respectively.

Each of the paired components (the first polyethylene component (C1), the second polyethylene component (C2), and third polyethylene component (C3)) from iCCD-SCBD and GPC-MWD are considered equivalent masses for their respective techniques as shown in Equations 14A-E.

$$w {f}_{C 1 , i C C D} + w {f}_{C 2 , i C C D} + w {f}_{C 3 , i C C D} = 1 \text{.00} \qquad ( Equation 14 A )$$

$$w {f}_{C 1 , GPC} + w {f}_{C 2 , GPC} + w {f}_{C 3 , GPC} = 1. \qquad ( Equation 14 B )$$

$$w {f}_{C 1 , i C C D} = w {f}_{C 1 , G P C} \qquad ( Equation 14 C )$$

$$w {f}_{C 2 , i C C D} = w {f}_{C 2 , G P C} \qquad ( Equation 14 D )$$

$$w {f}_{C 2 , iCCD} = w {f}_{C 2 , GPC} \qquad ( Equation 14 E )$$

Process and catalyst data, including catalysts efficiency and reactor mass balance, can be leveraged for initial estimates of the relative weight production of each component. Alternatively, initial estimates of the weight fraction for each component can be compared by integrating partial areas of the iCCD-SCBD or GPC-MWD plot of the polyethylene composition, especially noting visible areas with defined peaks or peak inflection points. For example, the peak area for each component in iCCD-SCBD curve, if well-separated may be estimated by dropping vertical lines between peaks. FIG. 2 in both patent publications WO201913394A1 and WO2019133373A1 provide an example of an iCCD-SCBD curve. These publications are incorporated herein in their entirety. Association of the molecular weight order and initial estimation of the molecular weight may be obtained from the peak positions of the associated component areas in the iCCD-SCBD and iCCD-MW plots and agreement should be expected with the GPC-CC measurements. In some cases, initial assignment of peak areas and composition may be obtained from a multi-modal GPC-MWD as the starting point and validated under the iCCD-SCBD and iCCD-MW plots.

Initial estimates of peak elution temperature, width, and tailing in iCCD-SCBD for each component can be obtained from a calibration of peak elution temperature, width, and tailing using a series of standard single-site samples for which we have a measured weight percent comonomer content by NMR. These calibrations can also inform about individual component comonomer content from the measured peak elution temperature.

Microsoft Excel® Solver is programmed to minimize the combined sum of squares of residuals between the wt_{sum,GPC}(lgMᵢ) and the measured GPC-MWD, and sum of squares of residuals between the wt_{sum,iCCD}(T) and the measured iCCD-SCBD (wherein the sampling width and areas of the two observed distributions are normalized in regards to each other). There is equal weighting given to the GPC-MWD and iCCD-SCBD fit as they are simultaneously converged. Initial estimated values for weight fraction and peak width in iCCD-SCBD as well as molecular weight target for each component are used for the Microsoft Excel® Solver to begin with as described herein.

Co-crystallization effects which distort peak shape in iCCD are compensated for by the use of the Exponentially-Modified Gaussian (EMG) peak fit and in extreme cases, the use of multiple (up to 3) EMG peaks summed to describe a single component. A component produced via a single site catalyst may be modeled by a single EMG peak. A component produced via a Ziegler-Natta catalyst may be modeled by 1, 2, or 3 EMG peaks, or a single EMG peak possessing a long low temperature-facing tail sufficing for a Ziegler-Natta component of very high density, very low molecular weight targets on the iCCD-SCBD plot. In all cases, only a single broadened Flory-Schulz distribution (Equation 13A-C) is used with the weight fraction assigned as the associated sum of one or more of the EMG components from the iCCD-SCBD model (Equations 14A-E).

The GPC deconvolution is constrained with a normal distribution width parameter (σ_{C1} or σ_{C2}) from Equation 13A, 13B between 0.000 and 0.170 (corresponding polydispersities of approximately 2.00 to 2.33) for the first and second polyethylene components which are made via single site catalysts. The M_{w,Target} in Equation 9 is constrained to be lowest for the third polyethylene component in these cases, since it is targeted to be the lowest from this specific reaction scheme. Note that it is not constrained to be lowest in all possible cases, depending upon the desired performance target of the combined resin in-reactor blend. The ranking (preliminary estimation) of the two weight-average molecular weights (M_{w,Target}) of the first polyethylene component and the second polyethylene component is observed by the M_{w(iCCD)} from the iCCD-MW plot (M_{w(iCCD)} vs. temperature curve) at the temperatures at which the first and second polyethylene component peaks are observed on the iCCD-SCBD plot (wt_{iCCD}(T) vs. temperature curve). Therefore, the order of the molecular weights for the three components is well-known. A reactor mass balance yields the percentage mass (Wf) of Equation 13C of the third polyethylene component, or alternatively it can be calculated from the deconvolution using Equation 13D, depending upon the strength of the known distribution models for iCCD and GPC and the total weight fraction must sum to unity (Equation 14 A-E).

In general, it has been found that approximately 20 solver iterations will typically reach good convergence on the solution using Excel®. If there is a disagreement in order of the peaks versus measured molecular weight by the iCCD-MW plot and the observed comonomer wt. % measurement measured via GPC-CC, then the data must be reconciled by changing the iteration starting points (temperature or log MW) in Excel or changing the width and tail factors slightly such that the iteration will proceed with convergence to a consistent solution amongst the measurements, or the resolution of the measurements must be increased, or an additional peak may be added to the iCCD-SCBD to better approximate the elution peak shape of the individual components. Such components could be modeled a-priori via several EMG distributions if they are prepared individually.

Additionally, a predicted M_{w(iCCD)} response for iCCD-MW may be generated by using the weight-average molecular weight by GPC-MWD of each of the components multiplied by the observed weight fraction of each of the components at each point along the iCCD-SCBD plot. The predicted M_{w(iCCD)} needs to agree with the measured M_{w(iCCD)} in the iCCD-MW plot. By plotting comonomer incorporation as a function of elution temperature based on a series of known copolymer standards, the GPC-CC plot can also be predicted using the measured M_{w(iCCD)} and comonomer incorporation of individual component from iCCD-MW and iCCD-SCBD plots. The predicted GPC-CC plot needs to agree with the measured GPC-CC.

A peak temperature vs. density correlation for the iCCD-SCBD data is obtained using a series of linear ethylene-based polymer standard resins polymerized from single site catalysts of approximately 1 g/10 min melt index (I₂), or nominal weight-average molecular weight of approximately 105,000 g/mol by GPC, and polydispersities (or MWD) of less than 2.3 by GPC. At least 10 standard resins of known comonomer content, density, and molecular weight within the density range of 0.87 to 0.96 g/cc are used. Peak temperature and density data are fit with a 5th order polynomial curve to obtain the calibration curve.

A peak width and peak tail vs. peak temperature correlation is obtained similarly by fitting the peak width and peak tail vs. temperature of the above resins with a linear line, which is very useful for initial estimates in the deconvolution process.

The first polyethylene component and the second polyethylene component were noted in the inventive resins presented herein directly from the iCCD-SCBD deconvolution plot as the first two peaks between 35° C. and 90° C. elution temperature. A “Raw Density” (Density_{Raw}) was calculated from these observed peak positions using the calibration curve of peak temperature vs. density. The Density_{Raw} (in g/cc) was corrected to Density_{True} (in g/cc) accounting for molecular weight (in g/mol) contributions by using the Equation 15:

$${Density}_{True} = {Denisity}_{R a w} - 0.2 \; 54 g / {cm}^{3} \times [ l g ( {M}_{w ( G P C )} / ( g / mol ) ) - 5.02 ] \qquad ( Equation 15 )$$

where M_{w(GPC)} is the weight-average molecular weight of the single component deconvoluted from GPC-MWD.

The density of the third polyethylene component may be calculated based on the known density of the resin, Density_{True} of the first polyethylene component, Density_{True} of the second polyethylene component, and the weight fractions of each components according to the following Equation 16.

$$\frac{1}{{Density}_{measured}} = \frac{weight fraction of 1 st polyethylene component}{{Density}_{True} of 1 st polyethylene component} + \frac{weight fraction of 2 nd polyethylene component}{{Density}_{True} of 2 nd polyethylene component} + \frac{weight fraction of 3 rd polyethylene component}{density of 3 rd polyethylene component} \qquad ( Equation 16 )$$

The melt index (I₂) of each polyethylene component may be estimated from their weight-average molecular weight by the following equation:

$$lg ( {I}_{2} / ( g / 10 min ) ) = - 3.759 \times l g ( {M}_{w ( G P C )} / ( g / mol ) ) + 18.9 \qquad ( Equation 17 )$$

where M_{w(GPC)} is the weight average molecular weight (in g/mol) of the single component deconvoluted from GPC-MWD curve and I₂ is the melt index in (g/10 min). Note that the amount of long chain branching may change the coefficients. Moreover, for the determination of product composition, direct sampling of a single reactor with a single catalyst with the same reactor conditions, a first reactor sampling for a series dual-reactor configuration, or sampling of both reactors for a parallel dual-reactor configuration may be used to aid in the determination of the density, melt index (I₂), GPC-MWD, and iCCD-SCBD of each individual component of the polyethylene composition, especially providing that the reaction is effectively killed past the sampling point. This allows better confirmation in cases, wherein the first and second polyethylene component peak positions cannot adequately be determined from the 3-component mixture.

Direct examination and quantitation by analytical cross-fractionation in GPC-TREF, such as the PolymerChar CFC unit (Valencia, Spain) equipped with on-line light scattering and employing similar calibrations in bivariate space representing SCBD and molecular weight and calibrating the relationship to density may be used to measure amounts or discriminate more precisely of each of the components as well, especially for the initial estimates or in cases that may produce high co-crystallization or low resolution/discrimination of species particularly in both MWD and SCBD space. (Development of an Automated Cross-Fractionation Apparatus (TREF-GPC) for a Full Characterization of the Bivariate Distribution of Polyolefins. Polyolefin Characterization. Macromolecular Symposia, Volume 257, 2007, Pages 13-28. A. Ortin, B. Monrabal, J. Sancho-Tello) Adequate resolution must be obtained in both lgMW and temperature space and verification should be done through both direct compositional ratioing, for example, IR-5 and light scattering molecular weight measurement. See Characterization of Chemical Composition along the Molar Mass Distribution in Polyolefin Copolymers by GPC Using a Modem Filter-Based IR Detector. Polyolefin Characterization —ICPC 2012 Macromolecular Symposia Volume 330, 2013, Pages 63-80, A. Ortin, J. Montesinos, E. López, P. del Hierro, B. Monrabal, J.R. Torres-Lapasi6, M.C. Garcia-Alvarez-Coque. Deconvolution of the components must use a similar set of equations and analogous calibration verified by a series of single-site resins and resin blends.

### Branching Measurements

SCB_{log Mw4-5} (averaged short chain branch level of log(Mw) in between 4.0 and 5.0) The composition was tested using GPC. The GPC system consists of a 150° C. high temperature chromatograph equipped with a Polymer Char IR-5 infrared detector, a two-angle light scattering detector (Agilent 1260) and a differential viscometer from Polymer Char. Four PL Mixed A columns (7.5×300 mm), commercially available from Agilent, are installed in series before the IR-5 detector in the detector oven. 1,2,4-trichlorobenzene (TCB, HPLC grade) and 2,5-di-tert-butyl-4-methylphenol (BHT) (such as commercially available from Sigma-Aldrich) are obtained. Eight hundred milligrams of BHT are added to four liters of TCB. TCB containing BHT is now referred to as “TCB.” Sample preparation is done with an autosampler at 2 mg/mL under shaking at 160° C. for 3 hours. The injection volume is 200 ml. The temperature of GPC is 150° C. and the flow rate is 1 mL/min. The GPC is calibrated using a series of narrow molecular weight (Mw) polystyrene standards.

Calibration of the GPC column set is performed with 21 narrow molecular weight distribution polystyrene standards with molecular weights ranging from 580 to 9,835,000 and are arranged in six “cocktail” mixtures with at least a decade of separation between individual molecular weights. A fifth order polynomial is used to fit the respective polyethylene-equivalent calibration points. The polystyrene standard peak molecular weights are converted to polyethylene molecular weights.

IR-5 infrared detector is used to measure the composition along with MWD. The composition detector is calibrated using a series of copolymer standards having varying levels of co-monomer. The wt % co-monomer levels of these samples are obtained by C¹³ NMR. For each standard, the composition related signals are collected, labelled as “Measurement”, “Methylene” (CH₂) and “Methyl” (CH₃). The “Measurement” signal is used as concentration signal when performing molecular weight calibration, while the ratio of the “Methyl” and “Methylene” signals are used for the composition calculation. Plots of the wt % co-monomer from NMR versus these ratios for the series of standards are made. A linear regression of the data results in good fits of the data sets. The wt % co-monomer data can be converted to short chain branching in 1000 total carbon (SCB/1000C).

Mw is the weight average molecular weight. log Mw is the logarithm of weight average molecular weight. w_{log Mw} is weight fraction of the portion at specific log Mw. S_{log Mw} is short chain branch per 1000 carbons of the portion at specific log Mw. SCB_{log Mw4-5} in (SCB/1000C) is calculated by below equation:

$$S C {B}_{logMw 4 \sim 5} = {\int }_{4.0}^{5.} {S}_{logMW} \cdot {w}_{logMw} \cdot d log Mw / {\int }_{4.0}^{5.0} {w}_{logMw} \cdot d log Mw$$

### Haze

Haze is measured in accordance with ASTM D1003 using BYK Gardner Haze-gard.

### Clarity

Clarity is measured in accordance with ASTM D1746.

### Film Tensile Measurements

Tensile modulus (including machine direction (MD) modulus and transverse direction (TD) modulus) is measured in accordance with 2% secant modulus in ASTM D882. Tensile strain at break is measured in accordance with ASTM D882.

Some embodiments of the invention will now be described in detail in the following Examples.

### EXAMPLES

### Table of Catalyst Components Used in the Synthesis of Polyethylene Compositions

The synthetic procedures for synthesizing the below metal-ligand complexes V and VI may be found in the following patent publications: WO2022015368A1 and WO2016014749A1, which are incorporated herein.

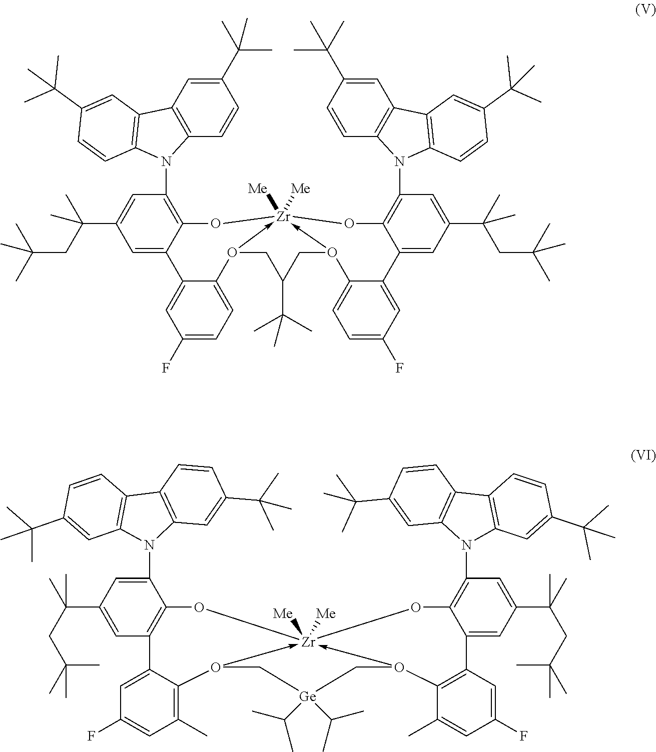

| | |
|---|---|
| Catalyst | Zirconium, dimethyl[3-(3,6-di-tert-butyl-9H-carbazol-9-yl)-2′-(2-(((3′- |
| component 1 | (3,6-di-tert-butyl-9H-carbazol-9-yl)-5-fluoro-2′-methyl-5′-(2,4,4- |
| (V) | trimethylpentan-2-yl)-[1,1′-biphenyl]-2-yl)oxy)methyl)-3,3- |
| | dimethylbutoxy)-5′-fluoro-5-(2,4,4-trimethylpentan-2-yl)-[1,1′-biphenyl] |
| Catalyst | Zirconium, dimethyl [2′,2″′- |
| component 2 | (((diisopropylgermanediyl)bis(methylene))bis(oxy))bis(3-(2,7-di-tert- |
| (VI) | butyl-9H-carbazol-9-yl)-5′-fluoro-3′-methyl-5-(2,4,4-trimethylpentan-2- |
| | yl)-[1,1′-biphenyl]) |
| Catalyst | Ziegler-Natta catalyst (catalyst metal = Ti) |
| component 3 | The heterogeneous Ziegler-Natta type catalyst-premix was prepared |
| | substantially according to U.S. Pat. No. 4,612,300, by sequentially adding |
| | to a volume of ISOPAR E, a slurry of anhydrous magnesium chloride in |
| | ISOPAR E, a solution of EtAlCl₂ in heptane, and a solution of Ti(O—iPr)₄ |
| | in heptane, to yield a composition containing a magnesium concentration |
| | of 0.20M and a ratio of Mg/Al/Ti of 40/12.5/3. An aliquot of this |
| | composition can be further diluted with ISOPAR-E if required. The |
| | catalyst-premix is activated upon reaction with the designated ratio of tri- |
| | ethyl aluminum. |
| Co-catalyst 1 | bis(hydrogenated tallow alkyl)methylammonium |
| | tetrakis(pentafluorophenyl)borate |
| Co-catalyst 2 | modified methyl aluminoxane |
| Co-catalyst 3 | Tri-ethyl aluminum |

### Production of Inventive Polyethylene Composition 1 (Poly. 1), Inventive Polyethylene Composition 2 (Poly. 2), and Comparative Polyethylene Composition 3 (C-Poly. 3)

All raw materials (monomer and comonomer) and the process solvent (a narrow boiling range high-purity paraffinic and cycloparaffinic solvent) are purified with molecular sieves before introduction into the reaction environment. High purity hydrogen is supplied by shared pipeline and dried with molecular sieve. The reactor monomer feed stream is pressurized via a mechanical compressor to above reaction pressure. The solvent feed is pressurized via a pump to above reaction pressure. The comonomer feed is pressurized via a pump to above reaction pressure. The individual catalyst components are manually batch diluted with purified solvent and pressured to above reaction pressure. All reaction feed flows are measured with mass flow meters and independently controlled with metering pumps.

A dual series reactor configuration was used.

The first continuous solution polymerization reactor consists of a liquid full, near-adiabatic, and continuously stirred tank reactor (CSTR). Independent control of all solvent, monomer, comonomer, hydrogen, and catalyst component feeds is possible. The total feed stream to the reactor (solvent, monomer, comonomer, and hydrogen) is temperature controlled by passing the feed stream through a heat exchanger. The total feed to the polymerization reactor is injected into the reactor in one location. The catalyst components are injected into the polymerization reactor separate from the other feeds. The primary catalyst component feed is computer controlled to maintain the reactor monomer conversion at the specified target. The secondary catalyst component feed is set to a specified molar ratio to the total catalyst (Catalyst-B molar ratio=(Catalyst-B)mol/(Catalyst-A+Catalyst-B)mol*100). The boron containing cocatalyst component is fed based on specified molar ratio to the total catalyst metal (primary+secondary) being fed to the reactor. The Al containing cocatalyst component is fed to maintain a specified concentration of Al in the reactor. An agitator in the reactor is responsible for continuously mixing of the reactants. An oil bath provides for some fine tuning of the reactor temperature control and does allow for some amount of heat transfer from/to the reactor allowing deviation from adiabatic reactor behavior.

The effluent from the first polymerization reactor exits the first reactor and is added to the second reactor separate from the other feeds to the second reactor.

The second continuous solution polymerization reactor consists of a liquid full, near-adiabatic, and continuously stirred tank reactor (CSTR). Independent control of all solvent, monomer, comonomer, hydrogen, and catalyst component feeds is possible. The total feed stream to the reactor (solvent, monomer, comonomer, and hydrogen) is temperature controlled by passing the feed stream through a heat exchanger. The total feed to the polymerization reactor is injected into the reactor in one location. The catalyst components are injected into the polymerization reactor separate from the other feeds. The primary catalyst component feed is computer controlled to maintain the reactor monomer conversion at the specified target. The cocatalyst component is fed based on a specified molar ratio to the primary catalyst component. An agitator in the reactor is responsible for continuously mixing of the reactants. An oil bath provides for some fine tuning of the reactor temperature control and does allow for some amount of heat transfer from/to the reactor allowing deviation from adiabatic reactor behavior.

In all reactor configurations the second/final reactor effluent enters a zone where it is deactivated with the addition of and reaction with a suitable reagent (typically water). At this same reactor exit location other additives may also be added for polymer stabilization (Octadecyl 3,5-Di-Tert-Butyl-4-Hydroxyhydrocinnamate, Tetrakis(Methylene(3,5-Di-Tert-Butyl-4-Hydroxyhydrocinnamate))Methane, and Ti (2,4-Di-Tert-Butyl-Phenyl) Phosphite) and acid neutralization (typical acid scavenger calcium stearate).

Following catalyst deactivation and any additive addition, the reactor effluent enters a devolatization system where the polymer is removed from the non-polymer stream. The non-polymer stream is removed from the system. The isolated polymer melt is pelletized and collected. Table 1A below provides the reactor information for the productions of Poly. 1, Poly. 2, and C-Poly. 3

TABLE 1A
Reactor Information for Poly. 1, Poly. 2, C-Poly. 3

| Sample Description | | Poly. 1 | Poly. 2 | C-Poly. 3 |
|---|---|---|---|---|
| Reactor Configuration | Type | Dual Series | Dual Series | Dual Series |
| Comonomer type | Type | 1-octene | 1-octene | 1-octene |
| First Reactor Feed Solvent/ | g/g | 7.5 | 8.0 | 7.8 |
| Ethylene Mass Flow Ratio | | | | |
| First Reactor Feed Comonomer/ | g/g | 0.39 | 0.26 | 0.21 |
| Ethylene Mass Flow Ratio | | | | |
| First Reactor Feed Hydrogen/ | g/g | 1.6E−04 | 8.9E−05 | 2.2E−04 |
| Ethylene Mass Flow Ratio | | | | |
| First Reactor Temperature | °C | 160 | 160 | 160 |
| First Reactor Pressure | barg | 28 | 28 | 28 |
| First Reactor Ethylene Conversion | % | 86.0 | 85.4 | 86.0 |
| First Reactor Catalyst-A Type | Type | Catalyst | Catalyst | Catalyst |
| | | component 1 | component 1 | component 2 |
| First Reactor Catalyst-B Type | Type | Catalyst | Catalyst | None |
| | | component 2 | component 2 | |
| First Reactor Catalyst-B molar | ratio | 65.0 | 38.1 | 0.0 |
| ratio: (Catalyst-A)mol/ | | | | |
| (Catalyst-A + Catalyst-B)mol * 100 | | | | |
| First Reactor Co-Catalyst 1 Type | Type | Co-catalyst 1 | Co-catalyst 1 | Co-catalyst 1 |
| First Reactor Co-Catalyst 2 Type | Type | Co-catalyst 2 | Co-catalyst 2 | Co-catalyst 2 |
| First Reactor Co-Catalyst 1 to | Ratio | 3.4 | 2.0 | 1.2 |
| Catalyst Molar Ratio (B to | | | | |
| Catalyst Metal ratio) | | | | |
| First Reactor [Al] from | ppmw | 0.39 | 0.39 | 0.37 |
| Co-Catalyst 2 | | | | |
| First Reactor Residence Time | min | 7.6 | 7.6 | 7.3 |
| Percentage of Total Ethylene | wt % | 52.8% | 46.8% | 54.8% |
| Feed to First Reactor | | | | |
| Second Reactor Feed Solvent/ | g/g | 3.8 | 3.3 | 3.9 |
| Ethylene Mass Flow Ratio | | | | |
| Second Reactor Feed Comonomer/ | g/g | 0.711 | 0.130 | 0.711 |
| Ethylene Mass Flow Ratio | | | | |
| Second Reactor Feed Hydrogen/ | g/g | 2.6E−04 | 5.2E−04 | 1.5E−04 |
| Ethylene Mass Flow Ratio | | | | |
| Second Reactor Temperature | °C | 190 | 190 | 190 |
| Second Reactor Pressure | barg | 28 | 28 | 28 |
| Second Reactor Ethylene Conversion | % | 92.1 | 88.6 | 94.2 |
| Second Reactor Catalyst Type | Type | Catalyst | Catalyst | Catalyst |
| | | component 3 | component 3 | component 3 |
| Second Reactor Co-Catalyst 1 Type | Type | n/a | n/a | n/a |
| Second Reactor Co-Catalyst 2 Type | Type | Co-catalyst 3 | Co-catalyst 3 | Co-catalyst 3 |
| Second Reactor Co-Catalyst 1 | Ratio | n/a | n/a | n/a |
| to Catalyst Molar Ratio (B | | | | |
| to Catalyst Metal ratio) | | | | |
| Second Reactor Co-Catalyst 2 | Ratio | 4.5 | 4.4 | 15.5 |
| to Catalyst Molar Ratio (A1 | | | | |
| to Catalyst Metal ratio) | | | | |
| Second Reactor Residence Time | min | 5.2 | 5.1 | 5.2 |

### Production of Inventive Polyethylene Composition 3 (Poly. 3), Inventive Polyethylene Composition 4 (Poly. 4), Comparative Polyethylene Composition 1 (C-Poly. 1), and Comparative Polyethylene Composition 2 (C-Poly. 2)

All raw materials (monomer and comonomer) and the process solvent (a narrow boiling range high-purity isoparaffinic solvent, Isopar-E) are purified with molecular sieves before introduction into the reaction environment. Hydrogen is supplied pressurized as a high purity grade and is not further purified. The reactor monomer feed stream is pressurized via a mechanical compressor to above reaction pressure. The solvent and comonomer feed is pressurized via a pump to above reaction pressure. The individual catalyst components are manually batch diluted with purified solvent and pressured to above reaction pressure. All reaction feed flows are measured with mass flow meters and independently controlled with computer automated valve control systems.

A two-reactor system is used in a series configuration. The first continuous solution polymerization reactor consists of a liquid full, non-adiabatic, isothermal, circulating, loop reactor which mimics a continuously stirred tank reactor (CSTR) with heat removal. Independent control of all fresh solvent, monomer, comonomer, hydrogen, and catalyst component feeds is possible. The total fresh feed stream to the first reactor (solvent, monomer, comonomer, and hydrogen) is temperature controlled to maintain a single solution phase by passing the feed stream through a heat exchanger. The total fresh feed to each polymerization reactor is injected into the reactor at three locations with approximately equal reactor volumes between each injection location. The fresh feed is controlled with each injector receiving one third of the total fresh feed mass flow. The catalyst components are injected into the polymerization reactor at two different locations with similar reactor volumes between each injection location and each injection receiving half of the total flow. The primary catalyst component feed is computer controlled to maintain the reactor monomer conversion at the specified target. The secondary catalyst component feed is set to a specified molar ratio to the total catalyst (Catalyst-B molar ratio=(Catalyst-B)mol/(Catalyst-A+Catalyst-B)mol*100). The boron containing cocatalyst component is fed based on specified molar ratio to the total catalyst metal (primary+secondary) being fed to the reactor. The Al containing cocatalyst component is fed to maintain a specified concentration of Al in the reactor. Immediately following each reactor feed or catalyst injection location, the streams are mixed with the circulating polymerization reactor contents with static mixing elements. The contents of the reactor are continuously circulated through heat exchangers responsible for removing much of the heat of reaction and with the temperature of the coolant side responsible for maintaining an isothermal reaction environment at the specified temperature. Circulation around the reactor loop is provided by a pump. A sample system exists to periodically collect material from the first loop reactor. After collection, the sample is dried in a vacuum oven and submitted for GPC and iCCD analysis. The GPC and iCCD analysis provides a measurement of the polymer split between the primary catalyst and the secondary catalyst in the first reactor loop; the result of which can be used to adjust the secondary catalyst molar ratio to achieve the desired polymer split within the first reactor loop.

The effluent from the first polymerization reactor (containing solvent, monomer, comonomer, hydrogen, catalyst components, and polymer) exits the first reactor and is added to the second reactor.

The second continuous solution polymerization reactor consists of a liquid full, non-adiabatic, isothermal, circulating, loop reactor which mimics a continuously stirred tank reactor (CSTR) with heat removal. Independent control of all fresh solvent, monomer, comonomer, hydrogen, and catalyst component feeds is possible. The total fresh feed stream to the second reactor (solvent, monomer, comonomer, and hydrogen) is temperature controlled to maintain a single solution phase by passing the feed stream through a heat exchanger. The total fresh feed to each polymerization reactor is injected into the reactor at two locations with approximately equal reactor volumes between each injection location. The fresh feed is controlled with each injector receiving half of the total fresh feed mass flow. The catalyst components are injected into the polymerization reactor through injection stingers. The primary catalyst component feed is computer controlled to maintain the reactor monomer conversion at the specified target. The cocatalyst component is fed based on a specified molar ratio to the primary catalyst component. Immediately following each reactor feed and catalyst injection location, the streams are mixed with the circulating polymerization reactor contents with static mixing elements. The contents of each reactor are continuously circulated through heat exchangers responsible for removing much of the heat of reaction and with the temperature of the coolant side responsible for maintaining an isothermal reaction environment at the specified temperature. Circulation around each reactor loop is provided by a pump.

Upon exiting the second reactor loop, the second/final reactor effluent enters a post-reactor adiabatic pipe, with a total volume approximately 21.4% that of the two loop reactors combined, where the reaction continues for a period prior to entering a mixing zone where the reaction is stopped by catalyst deactivation with the addition of and reaction with a suitable reagent (water). At this same reactor exit location other additives are added for polymer stabilization (typical antioxidants suitable for stabilization during extrusion and blown film fabrication like Octadecyl 3,5-Di-Tert-Butyl-4-Hydroxyhydrocinnamate, Tetrakis(Methylene(3,5-Di-Tert-Butyl-4-Hydroxyhydrocinnamate))Methane, and Tris(2,4-Di-Tert-Butyl-Phenyl) Phosphite) and acid neutralization (typical acid scavenger calcium stearate).

Following catalyst deactivation and additive addition, the reactor effluent enters a devolatization system where the polymer is removed from the non-polymer stream. The isolated polymer melt is pelletized and collected. The non-polymer stream passes through various pieces of equipment which separate most of the ethylene which is removed from the system. Most of the solvent and unreacted comonomer is recycled back to the reactor after passing through a purification system. A small amount of solvent and comonomer is purged from the process.

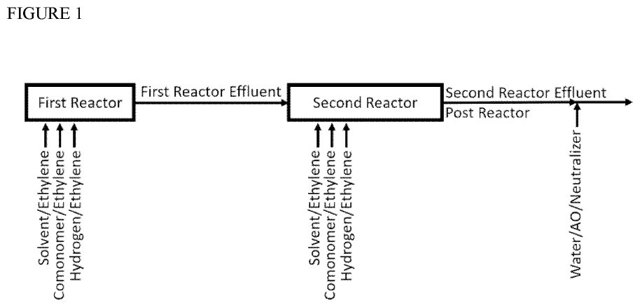

The reactor stream feed data flows that correspond to the values in Table 1B used to produced the example are graphically described in FIG. 1. The data are presented such that the complexity of the solvent recycle system is accounted for and the reaction system can be treated simply as a once through flow diagram.

TABLE 1B
Reactor Information for Poly. 3, Poly. 4, C-Poly. 1, and C-Poly. 2

| Sample Description | | Poly. 3 | Poly. 4 | C-Poly. 1 | C-Poly. 2 |
|---|---|---|---|---|---|
| Reactor Configuration | Type | Dual Series | Dual Series | Dual Series | Dual Series |
| Comonomer type | Type | 1-octene | 1-octene | 1-octene | 1-octene |
| First Reactor Feed Solvent/ | g/g | 4.89 | 4.87 | 4.61 | 4.92 |
| Ethylene Mass Flow Ratio | | | | | |
| First Reactor Feed Comonomer/ | g/g | 0.17 | 0.18 | 0.12 | 0.14 |
| Ethylene Mass Flow Ratio | | | | | |
| First Reactor Feed Hydrogen/ | g/g | 1.7E−04 | 2.2E−04 | 3.5E−04 | 9.3E−05 |
| Ethylene Mass Flow Ratio | | | | | |
| First Reactor Temperature | °C | 159.9 | 160.0 | 160.0 | 160.0 |
| First Reactor Pressure | barg | 50.0 | 50.0 | 50.0 | 50.0 |
| First Reactor Ethylene Conversion | % | 89.6 | 90.7 | 90.2 | 90.1 |
| First Reactor Catalyst A Type | Type | Catalyst | Catalyst | Catalyst | Catalyst |
| | | component 1 | component 1 | component 1 | component 1 |
| First Reactor Catalyst B Type | Type | Catalyst | Catalyst | Catalyst | Catalyst |
| | | component 2 | component 2 | component 2 | component 2 |
| First Reactor Catalyst-B molar | ratio | 28.3 | 33.3 | 27.3 | 13.0 |
| ratio: (Catalyst-A)mol/ | | | | | |
| (Catalyst-A + Catalyst-B)mol * 100 | | | | | |
| First Reactor Co-Catalyst 1 Type | Type | Co-catalyst 1 | Co-catalyst 1 | Co-catalyst 1 | Co-catalyst 1 |
| First Reactor Co-Catalyst 2 Type | Type | Co-catalyst 2 | Co-catalyst 2 | Co-catalyst 2 | Co-catalyst 2 |
| First Reactor Co-Catalyst 1 to | mol/mol | 9.8 | 10.0 | 10.9 | 9.7 |
| Catalyst Molar Ratio (B to | | | | | |
| Catalyst Metal ratio) | | | | | |
| First Reactor Co-Catalyst 2 reactor | ppm Al | 2.0 | 2.0 | 2.0 | 1.5 |
| concentration, ppm Al | | | | | |
| First Reactor Residence Time | min | 15.7 | 15.7 | 14.8 | 15.7 |
| Percentage of Total Ethylene Feed | wt % | 50.3% | 50.4% | 61.7% | 50.2% |
| to First Reactor | | | | | |
| Second Reactor Feed Solvent/ | g/g | 2.5 | 2.5 | 2.6 | 2.5 |
| Ethylene Mass Flow Ratio | | | | | |
| Second Reactor Feed Comonomer/ | g/g | 0.048 | 0.050 | 0.038 | 0.032 |
| Ethylene Mass Flow Ratio | | | | | |
| Second Reactor Feed Hydrogen/ | g/g | 6.3E−04 | 4.1E−04 | 5.6E−04 | 4.6E−04 |
| Ethylene Mass Flow Ratio | | | | | |
| Second Reactor Temperature | °C | 195 | 195 | 195 | 205 |
| Second Reactor Pressure | barg | 53 | 54 | 52 | 51 |
| Second Reactor Ethylene Conversion | % | 74.9 | 75.6 | 72.2 | 78.1 |
| Second Reactor Catalyst Type | Type | Catalyst | Catalyst | Catalyst | Catalyst |
| | | component 3 | component 3 | component 3 | component 3 |
| Second Reactor Co-Catalyst 1 Type | Type | None | None | None | None |
| Second Reactor Co-Catalyst 2 Type | Type | Co-catalyst 3 | Co-catalyst 3 | Co-catalyst 3 | Co-catalyst 3 |
| Second Reactor Co-Catalyst 1 to | mol/mol | N/A | N/A | N/A | N/A |
| Catalyst Molar Ratio (B to | | | | | |
| Catalyst Metal ratio) | | | | | |
| Second Reactor Co-Catalyst 2 to | mol/mol | 4.0 | 4.0 | 4.0 | 4.0 |
| Catalyst Molar Ratio (A1 to | | | | | |
| Catalyst Metal ratio) | | | | | |
| Second Reactor Residence Time | min | 5.3 | 5.3 | 5.7 | 5.2 |
| Post-reactor ethylene conversion | % | 51.5 | 52.0 | 50.0 | 46.0 |

The density, melt index (I₂), I₁₀/I₂, Mz, Mw/Mn, Mz/Mn, and Log(Mw) of 4.0 to 5.0 (SCB_{log Mw4-5}) of each of the inventive and comparative polyethylene compositions is measured in accordance with the Test Methods section above. Tables 2 and Table 3 below provide the data on the compositions.

TABLE 2
Inventive Polyethylene Composition Data

| | Unit | Poly. 1 | Poly. 2 | Poly. 3 | Poly. 4 |
|---|---|---|---|---|---|
| Density | g/cm³ | 0.938 | 0.940 | 0.942 | 0.940 |
| I₂ | g/10 min | 1.75 | 1.74 | 1.80 | 1.50 |
| I₁₀/I₂ | g/10 min | 7.11 | 12.66 | 14.8 | 11.4 |
| Mn (conv. gpc) | g/mol | 22,169 | 19,744 | 16,768 | 20,172 |
| Mw (conv. gpc) | g/mol | 97,566 | 101,105 | 93,009 | 98,678 |
| Mz (conv. gpc) | g/mol | 251,778 | 430,214 | 411,697 | 367,362 |
| Mw/Mn | | 4.40 | 5.12 | 5.55 | 4.89 |
| (conv. gpc) | | | | | |
| Mz/Mw | | 2.58 | 4.26 | 4.43 | 3.72 |
| (conv. gpc) | | | | | |
| Log(Mw) of | SCB/1000 C | 6.32 | 5.41 | 4.48 | 4.28 |
| 4.0 to 5.0 | | | | | |
| (SCB_{logMw4-5}) | | | | | |

TABLE 3
Comparative Polyethylene Composition Data

| | | C- | C- | C- |
|---|---|---|---|---|
| | Unit | Poly. 1 | Poly. 2 | Poly. 3 |
| Density | g/cm³ | 0.941 | 0.940 | 0.938 |
| I₂ | g/10 min | 1.60 | 1.75 | 1.78 |
| I₁₀/I₂ | g/10 min | 9.1 | 15.3 | 6.1 |
| Mn (conv. gpc) | g/mol | 22,129 | 18,925 | 24,545 |
| Mw (conv. gpc) | g/mol | 91,445 | 84,748 | 98,734 |
| Mz (conv. gpc) | g/mol | 282,437 | 419,458 | 227,625 |
| Mw/Mn | | 4.13 | 4.48 | 4.02 |
| (conv. gpc) | | | | |
| Mz/Mw | | 3.09 | 4.95 | 2.31 |
| (conv. gpc) | | | | |
| SCB/1000 C | | 3.46 | 4.96 | 4.38 |
| at Log(Mw) of | | | | |
| 4.0 to 5.0 | | | | |
| (SCB_{logMw4-5}) | | | | |

The densities, Mw, and weight percent (wt. %) of each of the components (Comp.) (i.e., polyethylene component 1 (Comp. 1), polyethylene component 2 (Comp. 2), and polyethylene component 3 (Comp. 3)) are measured in accordance with the Test Methods section above. Table 4A provides the results. Table 4B below provides the iCCD Peak Temperature of the First Polyethylene Component for each of the compositions. Table 4C below provides the values for each of the compositions for the following equation: First Polyethylene Component Weight Fraction*SCB_{log Mw4-5}*Mz (conv. GPC). Without being bound by theory, the properties, and balance of the properties, of First Polyethylene Component Weight Fraction, SCB_{log Mw4-5} Mz (conm. GPC), when greater than 230,000 results in improved and/or desirable processibility, stretchability, and performance in the films.

TABLE 4A

| | | | Deconvoluted | Deconvoluted | |
|---|---|---|---|---|---|
| | | Deconvoluted | Density | Mw | Deconvoluted |
| | | Wt. % | (g/cm³) | (g/mol) | I2 (g/10 min) |
| Poly. 1 | Comp. 1 | 25 wt. % | 0.943 | 213,000 | 0.083 |
| | Comp. 2 | 26 wt. % | 0.919 | 23,000 | 357 |
| | Comp. 3 | 49 wt. % | 0.945 | 75,000 | 4.2 |
| Poly. 2 | Comp. 1 | 17 wt. % | 0.933 | 333,000 | 0.012 |
| | Comp. 2 | 34 wt. % | 0.923 | 36,000 | 48 |
| | Comp. 3 | 49 wt. % | 0.951 | 46,000 | 19 |
| Poly. 3 | Comp. 1 | 20 wt. % | 0.934 | 318,000 | 0.014 |
| | Comp. 2 | 33 wt. % | 0.921 | 51,000 | 12 |
| | Comp. 3 | 47 wt. % | 0.960 | 28,000 | 116 |
| Poly. 4 | Comp. 1 | 21 wt. % | 0.935 | 283,000 | 0.02 |
| | Comp. 2 | 30 wt. % | 0.919 | 44,000 | 22 |
| | Comp. 3 | 49 wt. % | 0.955 | 44,000 | 21 |
| C-Poly. 1 | Comp. 1 | 23 wt. % | 0.938 | 219,000 | 0.05 |
| | Comp. 2 | 45 wt. % | 0.928 | 43,000 | 24 |
| | Comp. 3 | 42 wt. % | 0.952 | 59,000 | 7.4 |
| C-Poly. 2 | Comp. 1 | 6 wt. % | 0.928 | 545,000 | 0.002 |
| | Comp. 2 | 44 wt. % | 0.920 | 79,000 | 2.4 |
| | Comp. 3 | 50 wt. % | 0.958 | 36,000 | 46 |
| C-Poly. 3 | Comp. 1 | 50 wt. % | 0.943 | 138,000 | 0.30 |
| | Comp. 2 | 50 wt. % | 0.933 | 49,000 | 14 |
| | Comp. 3 | N/A* | N/A | N/A | N/A |

*C-Poly. 3 is a bimodal composition and only has two polyethylene components.

TABLE 4B
iCCD Peak Temperature of the First Polyethylene Component

| | | iCCD Peak |
|---|---|---|
| | | Temperature (C) |
| Poly. 1 | Comp. 1 | 99.7 |
| Poly. 2 | Comp. 1 | 100.1 |
| Poly. 3 | Comp. 1 | 100.2 |
| Poly. 4 | Comp. 1 | 100.0 |
| C-Poly. 1 | Comp. 1 | 100.4 |
| C-Poly. 2 | Comp. 1 | 99.8 |
| C-Poly. 3 | Comp. 1 | 100.2 |

TABLE 4C
Values of First Polyethylene Component Weight
Fraction * SCB_{logMw4-5} * Mz (conv. GPC)

| | First Polyethylene |
|---|---|
| | Component Weight Fraction * |
| | SCB_{logMw4-5} * Mz (conv. GPC) |
| Poly. 1 | 397809 |
| Poly. 2 | 395668 |
| Poly. 3 | 368881 |
| Poly. 4 | 330185 |
| C-Poly. 1 | 224763 |
| C-Poly. 2 | 124831 |
| C-Poly. 3 | 0 |

The polyethylene compositions are used to form biaxially oriented films. Three films are formed from each of the inventive polyethylene compositions, such that a total of twelve (12) inventive films are made. Biaxial orientation is conducted sequentially in two different stretch chambers at pre-determined temperatures. Sheet samples are cut into 10×10 cm size along MID and TD directions with an initial sheet thickness of 700 μm and loaded onto the stretching frame, with five clips positioned at each of the four sides. The clips are pneumatically driven to clamp the sample edges, and then the stretching frame is transported into the first chamber. The machine direction orientation (MDO) is conducted in the first chamber. Immediately after that, the sample oriented in machine direction is sent to the second chamber for cross or transverse direction orientation (TDO). In the MDO step, the sample sheet is firstly heated by hot air with forced convection at desired temperature (T_{MDO}=128° C.) for 180 seconds, then stretched to 5 times in machine direction with 5008/2 of stretch rate. In the TDO step, the sample is heated by circulating air in the second chamber at desired temperature (T_{TDO}=124, 126, and 128° C., respectively, as noted in the below table) for 30 seconds, prior the 8 times transverse direction orientation with 250l/m of stretch rate. Accordingly, the films are stretched in the cross direction at a ratio of 8:1 and in the machine direction at a ratio of 5:1, with a final film thickness about 20 μm. Stretched film sample was then unloaded from the stretching frame, aged for at least one week before tested for film properties as described below in this section. Tables 5 and 6 below provide the properties of the films. The inventive films have desirable clarity, haze modulus, and tensile properties. The films that are attempted to be formed from the comparative polyethylene compositions are not stretchable with film breakage during stretching, and so cannot be formed.

TABLE 5

| Polyethylene | | MDO Temperature/TDO | Clarity | Haze |
|---|---|---|---|---|
| Composition | Film | Temperature (°C) | (%) | (%) |
| Poly. 1 | Inventive | MD128/TD124 | 42 | 11 |
| | Film 1 | | | |
| Poly. 1 | Inventive | MD128/TD126 | 40 | 11 |
| | Film 2 | | | |
| Poly. 1 | Inventive | MD128/TD128 | 30 | 14 |
| | Film 3 | | | |
| Poly. 2 | Inventive | MD128/TD124 | 82 | 6 |
| | Film 4 | | | |
| Poly. 2 | Inventive | MD128/TD126 | 83 | 5 |
| | Film 5 | | | |
| Poly. 2 | Inventive | MD128/TD128 | 83 | 5 |
| | Film 6 | | | |
| Poly. 3 | Inventive | MD128/TD124 | 36 | 6.1 |
| | Film 7 | | | |
| Poly. 3 | Inventive | MD128/TD126 | 42 | 6.6 |
| | Film 8 | | | |
| Poly. 3 | Inventive | MD128/TD128 | 34 | 7.5 |
| | Film 9 | | | |
| Poly. 4 | Inventive | MD128/TD124 | 51 | 6.3 |
| | Film 10 | | | |
| Poly. 4 | Inventive | MD128/TD126 | 50 | 6.3 |
| | Film 11 | | | |
| Poly. 4 | Inventive | MD128/TD128 | 46 | 9.0 |
| | Film 12 | | | |
| C-Poly. 1 | Comparative | Not stretchable/ | | |
| | Film 1 | film break | | |
| C-Poly. 2 | Comparative | Not stretchable/ | | |
| | Film 2 | film break | | |
| C-Poly. 3 | Comparative | Not stretchable/ | | |
| | Film 3 | film break | | |

TABLE 6
Modulus and Tensile Data

| | | | MD | CD |
|---|---|---|---|---|
| | | | Elongation: | Elongation: |
| | 2% Secant | 2% Secant | tensile | tensile |
| | Modulus MD- | Modulus TD- | strain at | strain at |
| Film | (Mpa) | (Mpa) | break (%) | break (%) |
| Inventive | 735 | 1634 | 188 | 25 |
| Film 1 | | | | |
| Inventive | 710 | 1357 | 183 | 37 |
| Film 2 | | | | |
| Inventive | 628 | 1001 | 210 | 46 |
| Film 3 | | | | |
| Inventive | 900 | 1337 | 162 | 47 |
| Film 4 | | | | |
| Inventive | 821 | 1288 | 163 | 51 |
| Film 5 | | | | |
| Inventive | 830 | 1158 | 174 | 58 |
| Film 6 | | | | |
| Inventive | 839 | 1513 | 169 | 36 |
| Film 7 | | | | |
| Inventive | 880 | 1558 | 164 | 28 |
| Film 8 | | | | |
| Inventive | 741 | 1203 | 210 | 30 |
| Film 9 | | | | |
| Inventive | 910 | 1520 | 262 | 25 |
| Film 10 | | | | |
| Inventive | 855 | 1428 | 233 | 28 |
| Film 11 | | | | |
| Inventive | 810 | 1158 | 182 | 31 |
| Film 12 | | | | |

1. A polyethylene composition comprising:
(a) from 15 to 25 percent by weight of a first polyethylene component having a molecular weight (Mw) of greater than 200,000 g/mol and a density of from 0.925 to 0.945 g/cc;
(b) from 20 to 35 percent by weight of a second polyethylene component having a molecular weight (Mw) of less than 80,000 g/mol and a density of from 0.915 to 0.950 g/cc; and
(c) from 40 to 65 percent by weight of a third polyethylene component having a molecular weight (Mw) of less than 100,000 g/mol and a density of from 0.940 to 0.965 g/cc; and
wherein the polyethylene composition has a density of from 0.935 to 0.958 g/cc, a melt index (I₂) of from 0.5 to 5.0 g/10 min, and satisfies the following equation:
First Polyethylene Component Weight Fraction*SCB_{log Mw4-5}*Mz (conv. GPC)>230,000.

2. The polyethylene composition of claim 1, wherein the polyethylene composition has an average short chain branch level in a portion between log(Mw) of 4.0 to 5.0 (SCB_{log Mw4-5}) that is greater than 3.50 SCB/1000C and less than 10.00 SCB/1000C.

3. The polyethylene composition of claim 1, wherein the first polyethylene component has a peak temperature in an elution profile via improved comonomer composition distribution (iCCD) of greater than 99.5° C.

4. The polyethylene composition of claim 1, wherein the polyethylene composition has a Mz/Mw of from 2.5 to 4.5.

5. The polyethylene composition of claim 1, wherein the polyethylene composition has a molecular weight distribution (Mw/Mn) of from 4.2 to 10.0.

6. The polyethylene composition of claim 1, wherein the polyethylene composition has an I₁₀/I₂ of from 7.0 to 15.0.

7. The polyethylene composition of claim 1, wherein the polyethylene composition has a Mz (conv. GPC) of from 250,000 to 450,000 g/mol.

8. A uniaxially oriented film comprising the polyethylene composition according to claim 1.

9. A biaxially oriented film comprising the polyethylene composition according to claim 1.

10. The biaxially oriented film of claim 9, wherein the biaxially oriented film is oriented in the machine direction at a draw ratio from 2:1 to 9:1 and in the cross direction at a draw ratio from 2:1 to 11:1.

11. The biaxially oriented film of claim 9, wherein the biaxially oriented film is a multilayer film.

12. The biaxially oriented film of claim 9, wherein the biaxially oriented film has at least one of the following: a haze value of less than 15 percent; a 2 percent secant modulus in the machine direction of at least 600 MPa; a 2 percent secant modulus in the cross direction of at least 900 MPa; a clarity of at least 35 percent; a machine direction tensile strain at break of at least 160%; and a cross direction tensile strain at break of at least 20%.

13. A laminate comprising:
a first film comprising a polyethylene sealant film, polypropylene, or polyamide; and
the biaxially oriented film according to claim 9, wherein the first film is laminated to the biaxially oriented film.

14. An article comprising the biaxially oriented film according to any of claim 9.
